(19) United States
(12) Patent Application Publication
(10) Pub. No.: US 2013/0093856 A1
(43) Pub. Date: Apr. 18, 2013

(54) STEREOSCOPIC IMAGING DIGITAL CAMERA AND METHOD OF CONTROLLING OPERATION OF SAME

(71) Applicant: Fujifilm Corporation, Tokyo (JP)

(72) Inventor: Akihiro UCHIDA, Saitama-shi (JP)

(73) Assignee: FUJIFILM CORPORATION, Tokyo (JP)

(21) Appl. No.: 13/692,445

(22) Filed: Dec. 3, 2012

Related U.S. Application Data
(63) Continuation of application No. PCT/JP2011/060497, filed on Apr. 22, 2011.

(30) Foreign Application Priority Data
Jun. 4, 2010 (JP) 2010-128381

(51) Int. Cl. H04N 13/02

(52) U.S. Cl. CPC H04N 13/0239
USPC 348/47

(57) ABSTRACT

A left-eye image and a right-eye image are captured by a left-eye image capture device and a right-eye image capture device, respectively. Faces are detected in respective ones of these images. If sizes of the detected faces are both large, it is deemed that the captured face is near the camera and difference between the distance from one image capture device to the face and the distance from the other image capture device to the face has great influence upon distance from the one image capture device to the face and upon distance from the other image capture device to the face. Focusing control of the one image capture device is carried out based upon distance (left-eye image) from this image capture device, and focusing control of the other image capture device is carried out based upon distance (right-eye image) from this image capture device.

### TECHNICAL FIELD

This invention relates to a stereoscopic imaging digital camera and to a method of controlling the operation of this camera.

### BACKGROUND ART

A stereoscopic imaging digital camera includes a left-eye image capture device and a right-eye image capture device. A left-eye image constituting a stereoscopic image is captured using the left-eye image capture device, and a right-eye image constituting the stereoscopic image is captured using the right-eye image capture device. Such stereoscopic imaging digital cameras include one (Japanese Patent Application Laid-Open No. 2007-110498) in which imaging processing is executed using an image capture device different from an image capture device that has performed AE, AF or the like, and one (Japanese Patent Application Laid-Open No. 2007-110500) in which AE is performed by one image capture device and AF is performed by another image capture device.

However, when the distance from the left-eye image capture device to the subject and the distance from the right-eye image capture device to the subject are different, there are instance where neither of the two images can be brought into focus.

### DISCLOSURE OF THE INVENTION

An object of the present invention is to bring into accurate focus, even if the distance from the left-eye image capture device to the subject and the distance from the right-eye image capture device to the subject are different.

A stereoscopic imaging digital camera according the present invention comprises: a left-eye image capture device for capturing a left-eye image (an image for left eye) constituting a stereoscopic image; a first focusing lens freely movable along the direction of an optic axis of the left-eye image capture device; a right-eye image capture device for capturing a right-eye image (an image for right eye image) constituting the stereoscopic image; a second focusing lens freely movable along the direction of an optic axis of the right-eye image capture device; an object detection device (object detection means) for detecting objects, which are to be brought into focus, from respective ones of the left-eye image captured by the left-eye image capture device and right-eye image captured by the right-eye image capture device; a determination device (determination means) for determining whether the sizes of both of the objects, the one detected from the left-eye image by the object detection device and the one detected from the right-eye image by the object detection device, are both equal to or larger than a first threshold value; and a focus control device, responsive to a determination made by the determination device that the sizes of both of the images are both equal to or larger than the first threshold value, for executing positioning of the first focusing lens, using the object detected from the left-eye image by the object detection device, in such a manner that the object detected from the left-eye image by the object detection device is brought into focus, and executing positioning of the second focusing lens, using the object detected from the right-eye image by the object detection device, in such a manner that the object detected from the right-eye image by the object detection device is brought into focus; and responsive to a determination made by the determination device that at least one object of both of the objects is smaller than the first threshold value, for executing either one of the positioning of the first focusing lens in such a manner that the object detected from the left-eye image by the object detection device is brought into focus or the positioning of the second focusing lens in such a manner that the object detected from the right-eye image by the object detection device is brought into focus, and, moreover, executing positioning of whichever focusing lens of the first focusing lens and second focusing lens has not undergone positioning, to a position corresponding to a position that has been decided by either one of the positioning processes.

The present invention also provides an operation control method suited to the stereoscopic imaging digital camera described above. Specifically, the present invention provides a method of controlling operation of a stereoscopic imaging digital camera having a left-eye image capture device for capturing a left-eye image constituting a stereoscopic image, a first focusing lens freely movable along the direction of an optic axis of the left-eye image capture device, a right-eye image capture device for capturing a right-eye image constituting the stereoscopic image, and a second focusing lens freely movable along the direction of an optic axis of the right-eye image capture device, the method comprising: an object detection device detecting objects, which are to be brought into focus, from respective ones of the left-eye image captured by the left-eye image capture device and right-eye image captured by the right-eye image capture device; a determination device determining whether the sizes of both of the objects, the one detected from the left-eye image by the object detection device and the one detected from the right-eye image by the object detection device, are equal to or larger than a first threshold value; and in response to a determination made by the determination device that the sizes of both of the images are equal to or larger than the first threshold value, a focus control device executing positioning of the first focusing lens, using the object detected from the left-eye image by the object detection device, in such a manner that the object detected from the left-eye image by the object detection device is brought into focus, and executing positioning of the second focusing lens, using the object detected from the right-eye image by the object detection device, in such a manner that the object detected from the right-eye image by the object detection device is brought into focus; and in response to a determination made by the determination device that at least one object of both of the objects is smaller than the first threshold value, the focus control device executing either one of the positioning of the first focusing lens in such a manner that the object detected from the left-eye image by the object detection device is brought into focus or the positioning of the second focusing lens in such a manner that the object detected from the right-eye image by the object detection device is brought into focus, and, moreover, executing positioning of whichever focusing lens of the first focusing lens and the second focusing lens has not undergone positioning, to a position corresponding to a position that has been decided by either one of the positioning processes.

In accordance with the present invention, objects (physical objects such as a face or flower) to be brought into focus are detected from respective ones of a left-eye image and right-eye image obtained by image capture. If the sizes of the object in the left-eye image and of the object in the right-eye image are both equal to or greater than a first threshold value, it is deemed that the distance from the stereoscopic imaging digital camera to the physical object represented by the objects is short. The shorter the distance to the physical object, the more focusing control is affected by a difference between the distance from the left-eye image capture device to the physical object and the distance for the right-eye image capture device to the physical object. In the present invention, if the sizes of the objects are equal to or greater than the first threshold value, positioning of the first focusing lens is executed, using the object detected from the left-eye image by the object detection device, in such a manner that the object detected from the left-eye image by the object detection device is brought into focus, and positioning of the second focusing lens is executed, using the object detected from the right-eye image by the object detection device, in such a manner that the object detected from the right-eye image by the object detection device is brought into focus. The object contained in the left-eye image and the object contained in the right-eye image are both brought into focus.

By way of example, if it has been determined by the determination device that the sizes of both of the images are both equal to or greater than the first threshold value, then the focus control device, based upon the position of the object detected from the left-eye image by the object detection device and the position of the object detected from the right-eye image by the object detection device, switches between first positioning processing for executing positioning of the first focusing lens, using the object detected from the left-eye image by the object detection device, in such a manner that the object detected from the left-eye image by the object detection device is brought into focus, and for executing positioning of the second focusing lens, using the object detected from the right-eye image by the object detection device, in such a manner that the object detected from the right-eye image by the object detection device is brought into focus, and second positioning processing for executing either one of the positioning of the first focusing lens in such a manner that the object detected from the left-eye image by the object detection device is brought into focus or the positioning of the second focusing lens in such a manner that the object detected from the right-eye image by the object detection device is brought into focus, and, moreover, executing positioning of whichever focusing lens of the first focusing lens and second focusing lens has not undergone positioning, to a position corresponding to a position that has been decided by either one of the positioning processes.

In response to a determination by the determination device that the sizes of both of the images are both equal to or greater than the first threshold value and, moreover, on account of at least one of the object detected from the left-eye image by the object detection device and the object detected from the right-eye image by the object detection device being spaced away from the center of the image horizontally by more than a second threshold value, the focus control device executes positioning of the first focusing lens, using the object detected from the left-eye image by the object detection device, in such a manner that the object detected from the left-eye image by the object detection device is brought into focus, and executes positioning of the second focusing lens, using the object detected from the right-eye image by the object detection device, in such a manner that the object detected from the right-eye image by the object detection device is brought into focus; and in response to a determination made by the determination device that at least one object of both of the objects is smaller than the first threshold value and, moreover, on account of both the object detected from the left-eye image by the object detection device and the object detected from the right-eye image by the object detection device not being spaced away from the centers of the images horizontally by more than the second threshold value, the focus control device executes either one of the positioning of the first focusing lens in such a manner that the object detected from the left-eye image by the object detection device is brought into focus or the positioning of the second focusing lens in such a manner that the object detected from the right-eye image by the object detection device is brought into focus, and, moreover, executes positioning of whichever focusing lens of the first focusing lens and second focusing lens has not undergone positioning, to a position corresponding to a position that has been decided by either one of the positioning processes.

In response to a determination by the determination device that the sizes of both of the images are equal to or greater than the first threshold value, and on account of at least one of the object detected from the left-eye image by the object detection device and the object detected from the right-eye image by the object detection device being spaced away from the center of the image horizontally by more than a second threshold value and, moreover, the absolute value of the sum of amount of horizontal offset from the center of the object detected from the left-eye image by the object detection device and amount of horizontal offset from the center of the object detected from the right-eye image by the object detection device being equal to or greater than a third threshold value, the focus control device executes positioning of the first focusing lens, using the object detected from the left-eye image by the object detection device, in such a manner that the object detected from the left-eye image by the object detection device is brought into focus, and executes positioning processing of the second focusing lens of the second focusing lens, using the object detected from the right-eye image by the object detection device, in such a manner that the object detected from the right-eye image by the object detection device is brought into focus; and in response to a determination made by the determination device that at least one object of both of the objects is smaller than the first threshold value, and on account of both the object detected from the left-eye image by the object detection device and the object detected from the right-eye image by the object detection device not being spaced away from the centers of the images horizontally by more than the second threshold value, and, moreover, the absolute value of the sum of amount of horizontal offset from the center of the object detected from the left-eye image by the object detection device and amount of horizontal offset from the center of the object detected from the right-eye image by the object detection device being less than the third threshold value, the focus control device executes either one of the positioning of the first focusing lens in such a manner that the object detected from the left-eye image by the object detection device is brought into focus or the positioning of the second focusing lens in such a manner that the object detected from the right-eye image by the object detection device is brought into focus, and, moreover, executes positioning of whichever focusing lens of the first focusing lens and second focusing lens has not undergone positioning, to a position corresponding to a position that has been decided by either one of the positioning processes.

The apparatus may further comprise a first zoom lens provided in front of the left-eye image capture device, and a second zooms lens provided in front of the right-eye image capture device. In this case, at least one threshold value from among the first threshold value, second threshold value and third threshold value would have been decided based upon the position of the first zoom lens and the position of the second zoom lens, by way of example.

### BRIEF DESCRIPTION OF THE DRAWINGS

FIG. 1 is a block diagram illustrating the electrical configuration of a stereoscopic imaging digital camera;

FIG. 2a illustrates the positional relationship between a camera and a subject, FIG. 2b an example of a left-eye image and FIG. 2c an example of a right-eye image;

FIG. 3a illustrates the positional relationship between a camera and a subject, FIG. 3b an example of a left-eye image and FIG. 3c an example of a right-eye image;

FIG. 4 is a flowchart illustrating the processing procedure of a stereoscopic imaging digital camera;

FIG. 5 is a flowchart illustrating the processing procedure of a stereoscopic imaging digital camera;

FIG. 6 illustrates the electrical configuration of an AF implementing changeover device;

FIG. 7 illustrates face-size comparison threshold values;

FIG. 8a illustrates the positional relationship between a camera and a subject, FIG. 8b an example of a left-eye image and FIG. 8c an example of a right-eye image;

FIG. 9a illustrates the positional relationship between a camera and a subject, FIG. 9b an example of a left-eye image and FIG. 9c an example of a right-eye image;

FIG. 10 is a flowchart illustrating the processing procedure of a stereoscopic imaging digital camera;

FIG. 11 illustrates the electrical configuration of an AF implementing changeover device;

FIG. 12 illustrates face-size comparison threshold values;

FIG. 13a illustrates the positional relationship between a camera and a subject, FIG. 13b an example of a left-eye image and FIG. 13c an example of a right-eye image;

FIG. 14a illustrates the positional relationship between a camera and a subject, FIG. 14b an example of a left-eye image and FIG. 14c an example of a right-eye image;

FIG. 15 is a flowchart illustrating the processing procedure of a stereoscopic imaging digital camera;

FIG. 16 illustrates the electrical configuration of an AF implementing changeover device;

FIG. 17 illustrates face-position symmetry determination threshold values;

FIG. 18a illustrates the positional relationship between a camera and a subject, FIG. 18b an example of a left-eye image and FIG. 18c an example of a right-eye image;

FIG. 19 is a flowchart illustrating the processing procedure of a stereoscopic imaging digital camera;

FIG. 20a illustrates the positional relationship between a camera and a subject, FIG. 20b an example of a left-eye image and FIG. 20c an example of a right-eye image;

FIG. 21a illustrates the positional relationship between a camera and a subject, FIG. 21b an example of a left-eye image and FIG. 21c an example of a right-eye image;

FIG. 22 is a flowchart illustrating the processing procedure of a stereoscopic imaging digital camera;

FIG. 23 is a flowchart illustrating the processing procedure of a stereoscopic imaging digital camera;

FIG. 24 illustrates the electrical configuration of an AF implementing changeover device;

FIG. 25 illustrates flower-size comparison threshold values;

FIG. 26a illustrates the positional relationship between a camera and a subject, FIG. 26b an example of a left-eye image and FIG. 26c an example of a right-eye image;

FIG. 27a illustrates the positional relationship between a camera and a subject, FIG. 27b an example of a left-eye image and FIG. 27c an example of a right-eye image;

FIG. 28a illustrates the positional relationship between a camera and a subject, FIG. 28b an example of a left-eye image and FIG. 28c an example of a right-eye image;

FIG. 29a illustrates the positional relationship between a camera and a subject, FIG. 29b an example of a left-eye image and FIG. 29c an example of a right-eye image;

FIG. 30 is a flowchart illustrating the processing procedure of a stereoscopic imaging digital camera;

FIG. 31 illustrates the electrical configuration of an AF implementing changeover device;

FIG. 32 illustrates flower-position comparison threshold values;

FIG. 33a illustrates the positional relationship between a camera and a subject, FIG. 33b an example of a left-eye image and FIG. 33c an example of a right-eye image;

FIG. 34a illustrates the positional relationship between a camera and a subject, FIG. 34b an example of a left-eye image and FIG. 34c an example of a right-eye image;

FIG. 35a illustrates the positional relationship between a camera and a subject, FIG. 35b an example of a left-eye image and FIG. 35c an example of a right-eye image;

FIG. 36a illustrates the positional relationship between a camera and a subject, FIG. 36b an example of a left-eye image and FIG. 36c an example of a right-eye image;

FIG. 37 is a flowchart illustrating the processing procedure of a stereoscopic imaging digital camera;

FIG. 38 illustrates the electrical configuration of an AF implementing changeover device;

FIG. 39 illustrates flower-position symmetry determination threshold values;

FIG. 40a illustrates the positional relationship between a camera and a subject, FIG. 40b an example of a left-eye image and FIG. 40c an example of a right-eye image; and

FIG. 41 is a flowchart illustrating the processing procedure of a stereoscopic imaging digital camera;

### BEST MODE FOR CARRYING OUT THE INVENTION

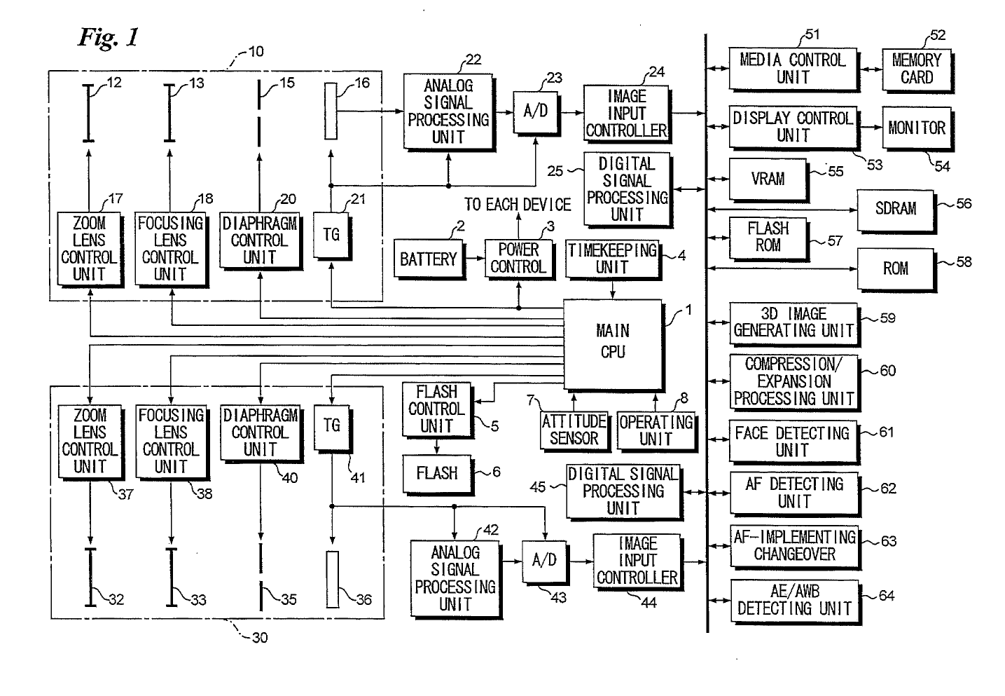

FIG. 1 illustrates an embodiment of the present invention and shows the electrical configuration of a stereoscopic imaging digital camera.

The overall operation of the stereoscopic imaging digital camera is controlled by a main CPU 1. The stereoscopic imaging digital camera is provided with an operating unit 8 that includes various buttons such as a mode setting button for setting an imaging mode and a playback mode, etc., a movie button for designating the beginning and end of recording of stereoscopic moving images, and a shutter-release button of two-stage stroke type. An operation signal that is output from the operating unit 8 is input to the main CPU 1.

The stereoscopic imaging digital camera includes a left-eye image capture device 10 and a right-eye image capture device 30. When the imaging mode is set, a subject is imaged continuously (periodically) by the left-eye image capture device 10 and right-eye image capture device 30.

The left-eye image capture device 10 images the subject, thereby outputting image data representing a left-eye image that constitutes a stereoscopic image. The left-eye image capture device 10 includes a first CCD 16. A first zoom lens 12, a first focusing lens 13 and a diaphragm 15 are provided in front of the first CCD 16. The first zoom lens 12, first focusing lens 13 and diaphragm 15 are driven by a zoom lens control unit 17, a focusing lens control unit 18 and a diaphragm control unit 20, respectively. When the imaging mode is set and the left-eye image is formed on the photoreceptor surface of the first CCD 16, a left-eye video signal representing the left-eye image is output from the first CCD 16 based upon clock pulses supplied from a timing generator 21.

The left-eye video signal that has been output from the first CCD 16 is subjected to prescribed analog signal processing in an analog signal processing unit 22 and is converted to digital left-eye image data in an analog/digital converting unit 23. The left-eye image data is input to a digital signal processing unit 25 from an image input controller 24. The left-eye image data is subjected to prescribed digital signal processing in the digital signal processing unit 25. Left-eye image data that has been output from the digital signal processing unit 25 is input to a 3D image generating unit 59.

The right-eye image capture device 30 includes a second CCD 36. A second zoom lens 32, second focusing lens 33 and a diaphragm 35 driven by a zoom lens control unit 37, a focusing lens control unit 38 and a diaphragm control unit 40, respectively, are provided in front of the second CCD 36. When the imaging mode is set and the right-eye image is formed on the photoreceptor surface of the second CCD 36, a right-eye video signal representing the right-eye image is output from the second CCD 36 based upon clock pulses supplied from a timing generator 41.

The right-eye video signal that has been output from the second CCD 36 is subjected to prescribed analog signal processing in an analog signal processing unit 42 and is converted to digital right-eye image data in an analog/digital converting unit 43. The right-eye image data is input to the digital signal processing unit 45 from an image input controller 44. The right-eye image data is subjected to prescribed digital signal processing in the digital signal processing unit 45. Right-eye image data that has been output from the digital signal processing unit 45 is input to the 3D image generating unit 59.

Image data representing the stereoscopic image is generated in the 3D image generating unit 59 from the left-eye image and right-eye image and is input to a display control unit 53. A monitor display unit 54 is controlled by the display control unit 53, whereby the stereoscopic image is displayed on the display screen of the monitor display unit 54.

When the shutter-release button is pressed through the first stage of its stroke, the items of left-eye image data and right-eye image data obtained as set forth above are input to an object detecting unit 61. The object detecting unit 61 detects faces from respective ones of the left-eye image represented by the left-eye image data and the right-eye image represented by the right-eye image data. In this embodiment, a face is detected in the object detecting unit 61. In an embodiment described later, however, a flower is detected in the object detecting unit 61. Thus, an object, which conforms to an objected detected, is detected in the object detecting unit 61.

When the shutter-release button is pressed through the first stage of its stroke, the items of left-eye image data and right-eye image data are to an AF detecting unit 62 as well. Focus-control amounts of the first focusing lens 13 and second focusing lens 33 are calculated in the AF detecting unit 62. The first focusing lens 13 and second focusing lens 33 are positioned at in-focus positions in accordance with the calculated focus-control amounts. In particular, in this embodiment, as will be described in detail later, if the size of a detected face (the ratio of the face to the image) is large, focusing control of the left-eye image capture device 10 is carried out using the data representing the face detected from the left-eye image (or using the left-eye image data), and focusing control of the right-eye image capture device 30 is carried out using the data representing the face detected from the right-eye image (or using the right-eye image data). On the other hand, if the size of a detected face is small, focusing control of both the left-eye image capture device 10 and right-eye image capture device 30 is carried out using the data representing the face detected from the left-eye image (or using the left-eye image data). This switching of focusing control is carried out by an AF-implementing changeover device 63.

The left-eye image data is input to an AE/AWB detecting unit 64. Respective amounts of exposure of the left-eye image capture device 10 and right-eye image capture device 30 are calculated in the AE/AWB detecting unit 64 using the data representing the face detected from the left-eye image (which may just as well be the right-eye image). The f-stop value of the first diaphragm 15, the electronic-shutter time of the first CCD 16, the f-stop value of the second diaphragm 35 and the electronic-shutter time of the second CCD 36 are decided in such a manner that the calculated amounts of exposure will be obtained. An amount of white balance adjustment is also calculated in the AE/AWB detecting unit 64 from the data representing the face detected from the entered left-eye image (or right-eye image). Based upon the calculated amount of white balance adjustment, the left-eye image is subjected to a white balance adjustment in the analog signal processing unit 22 and the right-eye image is subjected to a white balance adjustment in the analog signal processing unit 42.

When the shutter-release button is pressed through the second stage of its stroke, the image data (left-eye image data and right-eye image data) representing the stereoscopic image generated in the 3D image generating unit 59 is input to a compression/expansion unit 60. The image data representing the stereoscopic image is compressed in the compression/expansion unit 60. The compressed image data is recorded on a memory card 52 by a media control unit 51.

The stereoscopic imaging digital camera further includes a VRAM 55, an SDRAM 56, a flash ROM 57 and a ROM 58 for storing various data. The stereoscopic imaging digital camera further contains a battery 2. Power supplied from the battery 2 is applied to a power control unit 3. The power control unit 3 supplies power to each device constituting the stereoscopic imaging digital camera. The stereoscopic imaging digital camera further includes a flash unit 6 controlled by a flash control unit 5, and an attitude sensor 7.

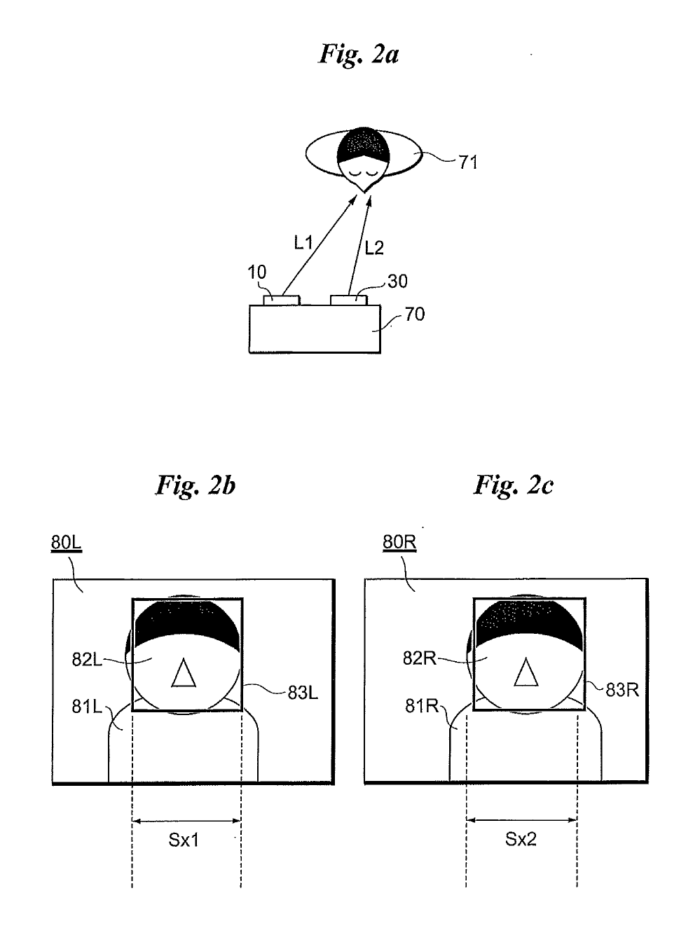

FIG. 2a illustrates the positional relationship between a subject and the stereoscopic imaging digital camera in a case where a face (object, physical object) is close to the stereoscopic imaging digital camera, FIG. 2b illustrates a left-eye image obtained by imaging, and FIG. 2c illustrates a right-eye image obtained by imaging.

With reference to FIG. 2a, a subject 71 is at a position in front of and comparatively close to a stereoscopic imaging digital camera 70. The subject 71 is imaged by the left-eye image capture device 10 of the stereoscopic imaging digital camera 70 to thus obtain the left-eye image. Similarly, the subject 71 is imaged by the right-eye image capture device 30 of the stereoscopic imaging digital camera 70 to thus obtain the right-eye image.

FIG. 2b is an example of the left-eye image obtained by imaging.

Left-eye image 80L contains a subject image 81L representing the subject 71. A face 82L is detected in the left-eye image 80L by executing face detection processing. A face frame 83L is being displayed so as to enclose the face 82L.

FIG. 2c is an example of the right-eye image obtained by imaging.

Right-eye image 80R contains a subject image 81R representing the subject 71. A face 82R is detected in the right-eye image 80R by executing face detection processing. A face frame 83R is being displayed so as to enclose the face 82R.

With reference to FIG. 2a, let the distance from the left-eye image capture device 10 to the subject (face) 71 be L1, and let the distance from the right-eye image capture device 30 to the subject (face) 71 be L2. If the distances L1 and L2 are short, the influence of the distance difference |L1−L2| upon the distance L1 or L2 is large. Therefore, if focusing control common to both the left-eye image capture device 10 and the right-eye image capture device 30 is carried out using the distance L1, the left-eye image obtained by the left-eye image capture device 10 will be brought into focus comparatively accurately, but the right-eye image obtained by the right-eye image capture device 30 will not be brought into focus very accurately. Similarly, if focusing control common to both the left-eye image capture device 10 and the right-eye image capture device 30 is carried out using the distance L2, the right-eye image obtained by the right-eye image capture device 30 will be brought into focus comparatively accurately, but the left-eye image obtained by the left-eye image capture device 10 will not be brought into focus very accurately. Accordingly, in this embodiment, if size Sx1 of the face 82L detected from the left-eye image 80L and size Sx2 of the face 82R detected from the right-eye image 80R are both equal to or greater than a first threshold value, then focusing control of the left-eye image capture device 10 is carried out based upon the distance L1 from the left-eye image capture device 10 to the subject (carried out based upon the face detected from the left-eye image) and, moreover, focusing control of the right-eye image capture device 30 is carried out based upon the distance L2 from the right-eye image capture device 30 to the subject (carried out based upon the face detected from the right-eye image). Both the left-eye image and right-eye image are brought into focus comparatively accurately.

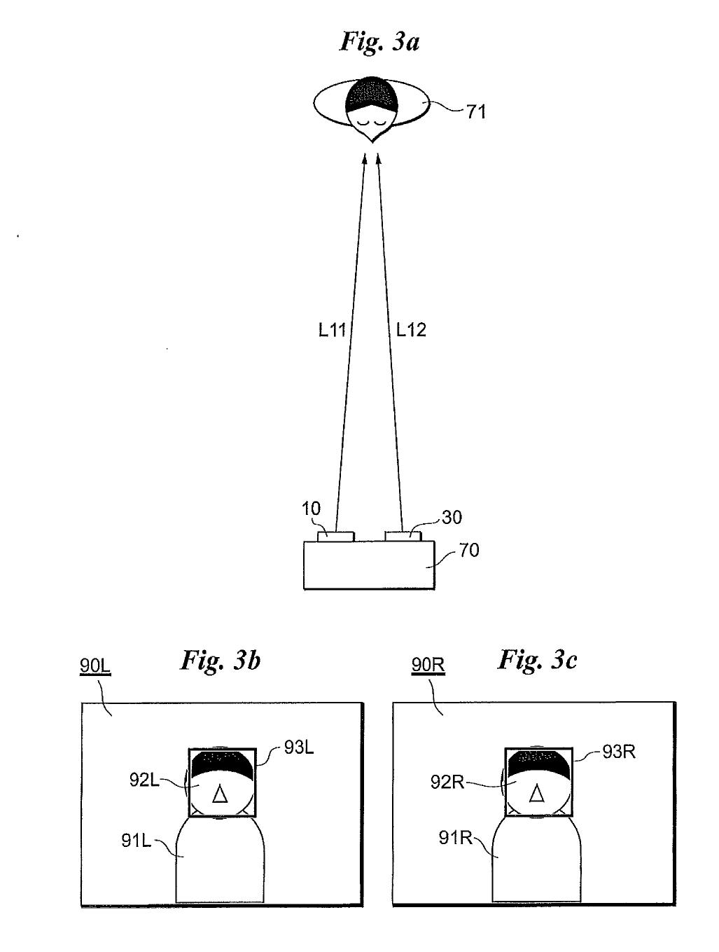

FIG. 3a illustrates the positional relationship between a subject and the stereoscopic imaging digital camera in a case where a face (physical object) is far from the stereoscopic imaging digital camera, FIG. 3b illustrates a left-eye image obtained by imaging, and FIG. 3c illustrates a right-eye image obtained by imaging.

With reference to FIG. 3a, the subject 71 is at a position in front of and far from the stereoscopic imaging digital camera 70. The subject 71 is imaged by the left-eye image capture device 10 of the stereoscopic imaging digital camera 70 to thus obtain the left-eye image. Similarly, the subject 71 is imaged by the right-eye image capture device 30 of the stereoscopic imaging digital camera 70 to thus obtain the right-eye image.

FIG. 3b is an example of the left-eye image obtained by imaging.

Left-eye image 90L contains a subject image 91L representing the subject 71. A face 92L is detected in the left-eye image 90L by executing face detection processing. A face frame 93L is being displayed so as to enclose the face 92L.

FIG. 3c is an example of the right-eye image obtained by imaging.

Right-eye image 90R contains a subject image 91R representing the subject 71. A face 92R is detected in the right-eye image 90R by executing face detection processing. A face frame 93R is being displayed so as to enclose the face 92R.

With reference to FIG. 3a, let the distance from the left-eye image capture device 10 to the subject (face) 71 be L11, and let the distance from the right-eye image capture device 30 to the subject (face) 71 be L12. If the distances L11 and L12 are long, the influence of the distance difference |L11−L12| upon the distance L11 or L12 is small. Therefore, even if focusing control common to both the left-eye image capture device 10 and the right-eye image capture device 30 is carried out using either the distance L11 or the distance L12, both the left-eye image and the right-eye image will be brought into focus comparatively accurately. Accordingly, in this embodiment, if either the size of the face 92L detected from the left-eye image 90L or the size of the face 92R detected from the right-eye image 90R is smaller than the first threshold value, then focusing control of both the left-eye image capture device 10 and right-eye image capture device 30 is carried out based upon the distance L11 from the left-eye image capture device 10 to the subject (based upon the face detected from the left-eye image) or the distance L12 from the right-eye image capture device 30 to the subject (based upon the face detected from the right-eye image).

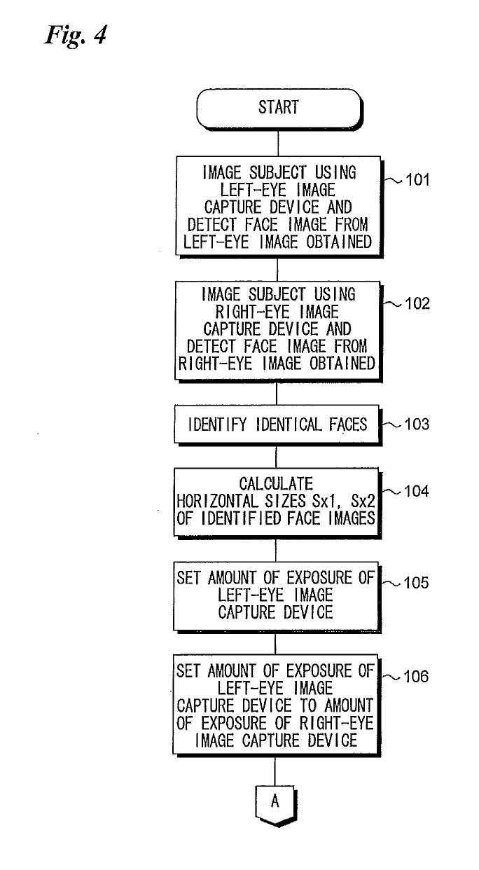

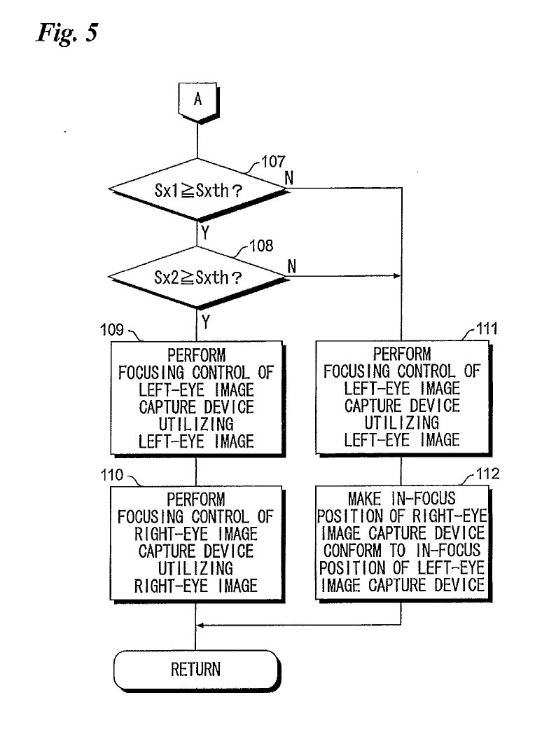

FIGS. 4 and 5 are flowcharts illustrating the processing procedure of the stereoscopic imaging digital camera.

Assume that the stereoscopic imaging digital camera has been set to the imaging mode and that a subject is being imaged periodically.

If the shutter-release button is pressed through the first stage of its stroke, as mentioned above, after such pressing of the button the subject is imaged by the left-eye image capture device 10 and a face is detected from the left-eye image obtained by imaging (step 101). Similarly, the subject is imaged by the right-eye image capture device 30 and a face is detected from the right-eye image obtained by imaging (step 102). The same face is identified between the face detected from the left-eye image and the face detected from the right-eye image (step 103). It goes without saying that agreement between image sizes or orientations or the like can be utilized in specifying an identical face. If an identical face is not found in both images, focusing control is performed in such a manner that the image center is brought into focus. If multiple identical faces are found, then one type of face is identified based upon whether it is the largest face or the face closest to the center position, etc.

Next, the horizontal (or vertical) size Sx1 of the face detected from the left-eye image and the horizontal size Sx2 of the face detected from the right-eye image are calculated (step 104).

Furthermore, in order to perform photometry using the left-eye image capture device 10, the amount of exposure of the left-eye image capture device 10 is decided from the left-eye image data obtained from the left-eye image capture device 10 (or from data representing the detected face), and this decided amount of exposure is set (step 105). Next, the right-eye image capture device 30 is also set in such a manner that an amount of exposure identical with that of the left-eye image capture device 10 will be obtained for this device (step 106). Photometry can be performed using the right-eye image capture device 30 and both the left-eye image capture device 10 and the right-eye image capture device 30 can be set to the amount of exposure decided.

It is determined whether the size Sx1 of the face detected from the left-eye image is equal to or greater than a first threshold value Sxth (step 107). If the size Sx1 is equal to or greater than the first threshold value Sxth (“YES” at step 107), then it is determined whether the size Sx2 of the face detected from the right-eye image is equal to or greater than a first threshold value Sxth (step 108). If the size Sx2 also is equal to or greater than the first threshold value Sxth (“YES” at step 108), then it is deemed that the distance to the subject (face) is short. Accordingly, as mentioned above, focusing control of the left-eye image capture device 10 (positioning of the first focusing lens 13) is carried out utilizing the face detected from the left-eye image (the distance from the left-eye image capture device 10 to the face; the left-eye image) (step 109). Furthermore, focusing control of the right-eye image capture device 30 (positioning of the second focusing lens 33) is carried out utilizing the face detected from the right-eye image (the distance from the right-eye image capture device 10 to the face; the right-eye image) (step 110).

If the size Sx1 of the face detected from the left-eye image is smaller than the first threshold value (“NO” at step 107), or if the size Sx2 of the face detected from the right-eye image is smaller than the first threshold value (“NO” at step 108), then focusing control of the left-eye image capture device 10 (positioning of the first focusing lens 13) is carried out utilizing the face detected from the left-eye image (the distance from the left-eye image capture device 10 to the face; the left-eye image) (step 111). Since the distance to the subject is deemed to be long, focusing control can be carried out comparatively accurately even if focusing control of the right-eye image capture device 30 (positioning of the second focusing lens 33) is carried out using the face detected from the left-eye image. Focusing control of the right-eye image capture device 30 therefore is carried out using the face detected from the left-eye image. An arrangement may be adopted in which focusing control of the right-eye image capture device 30 is carried out using the face detected from the right-eye image (the distance from the right-eye image capture device 30 to the subject; the right-eye image) and focusing control of the left-eye image capture device 10 is carried out using the right-eye image.

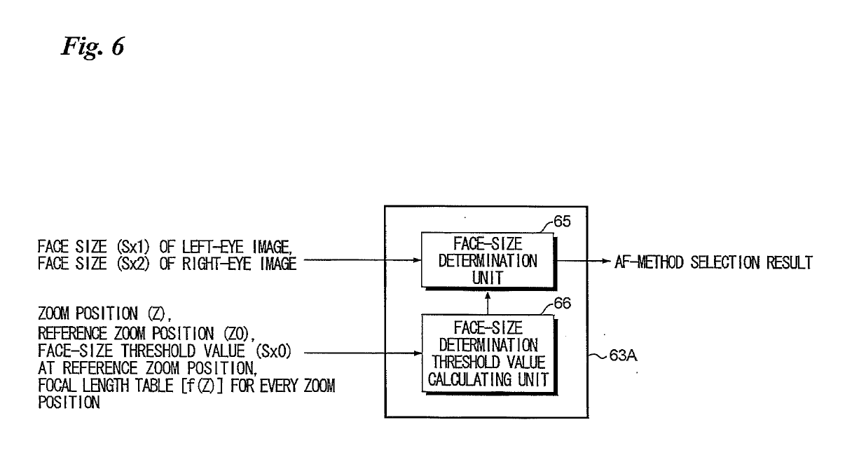

FIGS. 6 to 10 illustrate another embodiment. This embodiment pertains to a case where zoom lenses are utilized. In the above-described embodiment, the first threshold value is decided based upon face size. In this embodiment, however, the threshold value is decided upon referring to zoom position as well.

FIG. 6 illustrates the electrical configuration of an AF-implementing changeover device 63A.

The AF-implementing changeover unit 63A includes a face-size determination unit 65 and a face-size determination threshold value calculating unit 66. Input to the face-size determination unit 65 is data representing the size Sx1 of the face detected from the left-eye image and data representing the size Sx2 of the face detected from the right-eye image. Input to the face-size determination threshold value calculating unit 66 are a zoom position Z of the first zoom lens 12, a reference zoom position (either zoom lens position) Z0, a face-size threshold value Sx0 at the reference zoom position, and a focal length table f(Z) for every zoom position. A face-size comparison threshold value is calculated in the face-size determination threshold value calculating unit 66 based upon these items of input data. Data representing the calculated threshold value is input to the face-size determination unit 65.

If both of the face sizes Sx1 and Sx2 are equal to or greater than the decided threshold value, then the face-size determination unit 65 outputs data indicating an AF-method selection result according to which, as described above, focusing control of the left-eye image capture device 10 (positioning of the first focusing lens 13) is carried out utilizing the left-eye image (distance from the left-eye image capture device 10 to the face) and, moreover, focusing control of the right-eye image capture device 30 (positioning of the second focusing lens 33) is carried out utilizing the right-eye image (distance from the right-eye image capture device 10 to the face).

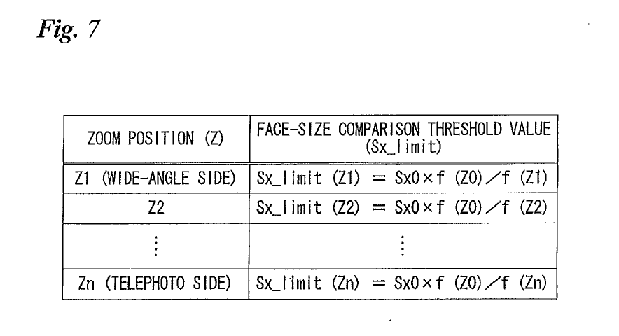

FIG. 7 illustrates the relationship between zoom position and a face-size comparison threshold value Sxlimit (first threshold value).

A face-size comparison threshold value Sxlimit has been decided in accordance with each zoom position Z. The relationship table shown in FIG. 7 can be stored in the above-mentioned face-size determination threshold value calculating unit 63A beforehand. The threshold value is calculated merely by inputting the zoom position Z to the face-size determination threshold value calculating unit 66.

It should be noted that in a case where distance d from the stereoscopic imaging digital camera 70 to the subject is the AF changeover point, Sx0=Sxd×d/f (Z0) holds, Sxd is the reference zoom position Z0, and face size is the size (width in the horizontal direction) of the face when the distance to the subject is d.

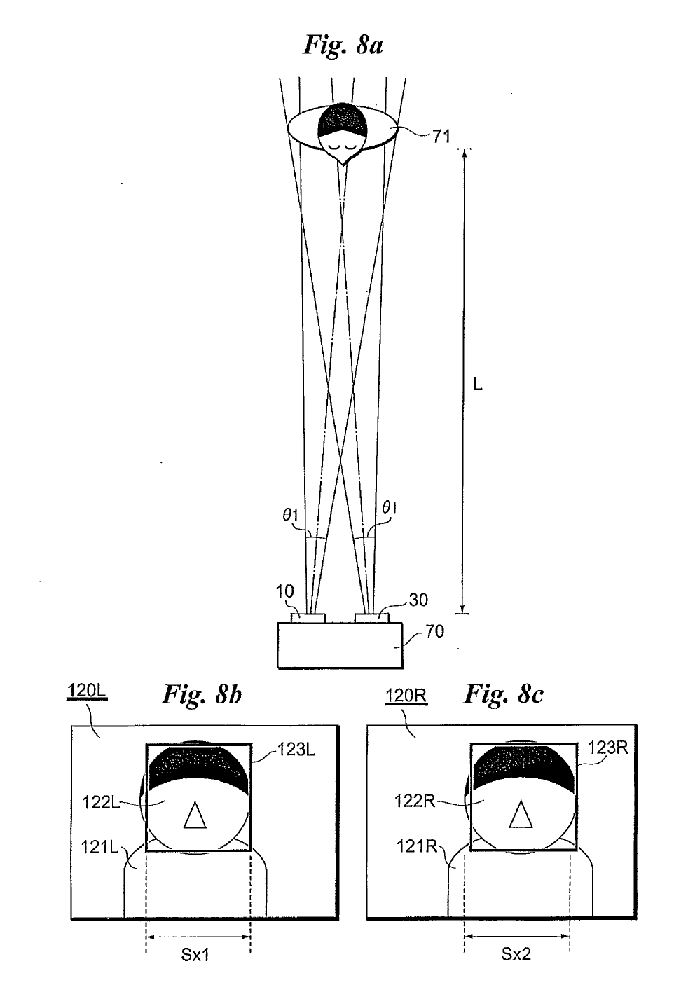

FIG. 8a illustrates the positional relationship between the stereoscopic imaging digital camera and the subject, FIG. 8b an example of a left-eye image obtained by imaging, and FIG. 8c an example of a right-eye image obtained by imaging.

With reference to FIG. 8a, the subject 71 is in front of and at a distance L from the stereoscopic imaging digital camera 70. Assume that both the zoom lens 12 of the left-eye image capture device 10 and the zoom lens 32 of the right-eye image capture device 30 have been set at telephoto zoom positions. The viewing angle is θ1 for both the left-eye image capture device 10 and the right-eye image capture device 30.

With reference to FIG. 8b, a left-eye image 120L is obtained by the left-eye image capture device 10. The left-eye image 120L includes a subject image 121L representing the subject 71. The subject image 121L includes a face 122L and the face is enclosed by a face frame 123L.

With reference to FIG. 8c, a right-eye image 120R is obtained by the right-eye image capture device 30. The right-eye image 120R also includes a subject image 121R representing the subject 71. A face 122R is enclosed by a face frame 123R.

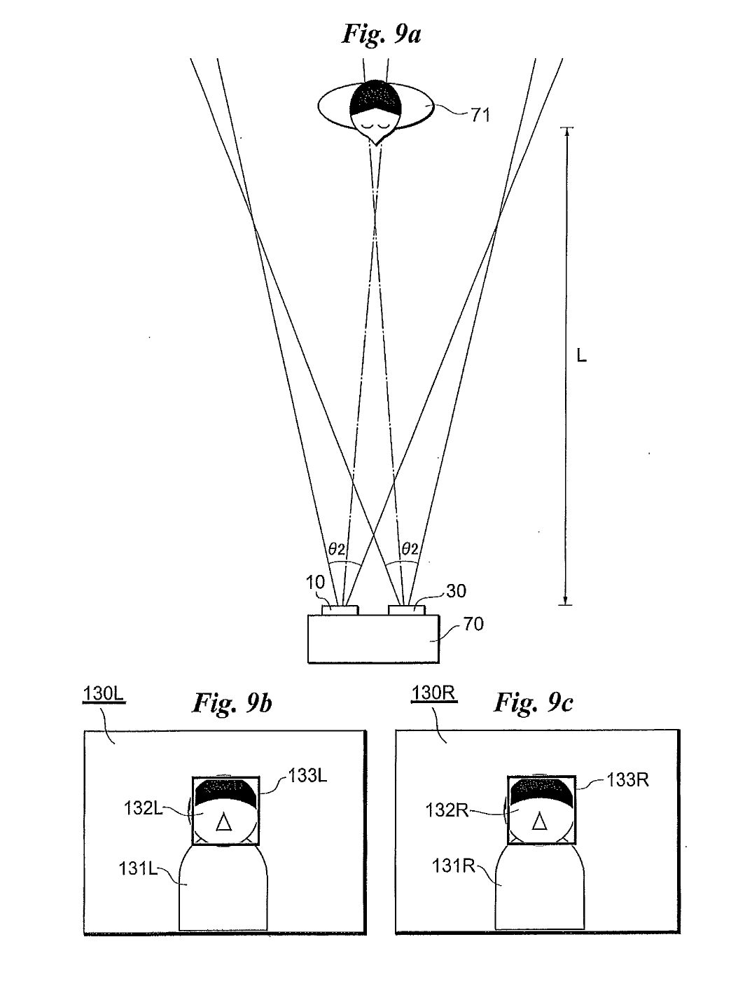

FIG. 9a illustrates the positional relationship between the stereoscopic imaging digital camera and the subject, FIG. 9b an example of a left-eye image obtained by imaging, and FIG. 9c a right-eye image obtained by imaging.

With reference to FIG. 9a, the subject 71 is in front of and at the distance L from the stereoscopic imaging digital camera 70. Assume that both the zoom lens 12 of the left-eye image capture device 10 and the zoom lens 32 of the right-eye image capture device 30 have been set at wide-angle zoom positions. The viewing angle is θ2 for both the left-eye image capture device 10 and the right-eye image capture device 30.

With reference to FIG. 9b, a left-eye image 130L is obtained by the left-eye image capture device 10. The left-eye image 130L includes a subject image 131L representing the subject 71. The subject image 131L includes a face 132L and the face is enclosed by a face frame 133L.

With reference to FIG. 9c, a right-eye image 130R is obtained by the right-eye image capture device 30. The right-eye image 130R also includes a subject image 131R representing the subject 71. A face 132R is enclosed by a face frame 133R.

As will be appreciated when FIGS. 8b and 8c are compared with FIGS. 9b and 9c, even in a case where the distances from the stereoscopic imaging digital camera 70 to the subject 71 are equal, namely the distance L, the face is larger on the telephoto side, even if the distance is lengthened, and the face is smaller on the wide-angle side. Thus, face size differs depending upon the zoom position of the zoom lenses. Accordingly, in this embodiment, a threshold value conforming to zoom position is utilized, as mentioned above.

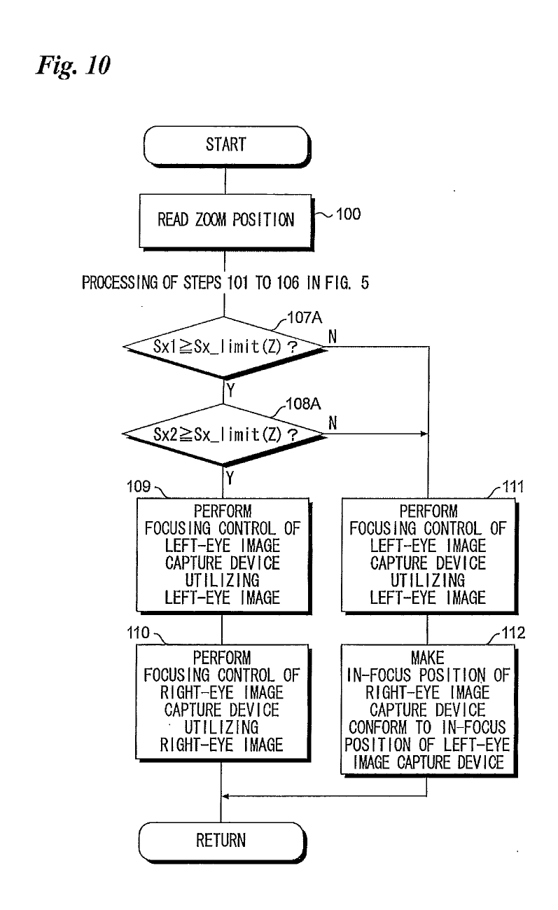

FIG. 10 is a flowchart illustrating the processing procedure of the stereoscopic imaging digital camera. Processing steps in FIG. 10 identical with those shown in FIG. 4 or FIG. 5 are designated by like step numbers and need not be described again.

When the shutter-release button is pressed through the first stage of its stroke, the zoom position (which may be the position of the first zoom lens 12 or of second zoom lens 32 because the lenses 12 and 32 are operatively associated) is read (step 100). Thereafter, as described above, processing is executed for calculating the size Sx1 of the face in the left-eye image and the size Sx2 of the face in the right-eye image (steps 101 to 106 in FIG. 5).

Next, it is determined whether the size Sx1 of the left-eye image is equal to or greater than the face-size comparison threshold value Sxlimit (first threshold value) that corresponds to the zoom position that has been read (step 107A). If the face size Sx1 is equal to or greater than the face-size comparison threshold value Sxlimit (“YES” at step 107A), then it is determined whether the size Sx2 of the right-eye image is equal to or greater than the face-size comparison threshold value Sxlimit that corresponds to the zoom position that has been read (step 108A). If the face size Sx2 also is equal to or greater than the face-size comparison threshold value Sxlimit (“YES” at step 108A), then it is deemed that the distance from the stereoscopic imaging digital camera 70 to the subject is comparatively short. As described above, focusing control of the left-eye image capture device 10 utilizing the face detected from the left-eye image is carried out (step 109) and focusing control of the right-eye image capture device 30 utilizing the face detected from the right-eye image is carried out (step 110).

If the face size Sx1 of the face in the left-eye image is less than the face-size comparison threshold value Sxlimit (“NO” at step 107A), or if the face size Sx2 of the face in the right-eye image is less than the face-size comparison threshold value Sxlimit (“NO” at step 108A), then it is deemed that the distance from the stereoscopic imaging digital camera 70 to the subject is comparatively long. As described above, focusing control of the left-eye image capture device 10 utilizing the face detected from the left-eye image is carried out (step 111) and focusing control of the right-eye image capture device 30 is carried out to make the in-focus position thereof conform to the in-focus position of the left-eye image capture device 10 (step 112).

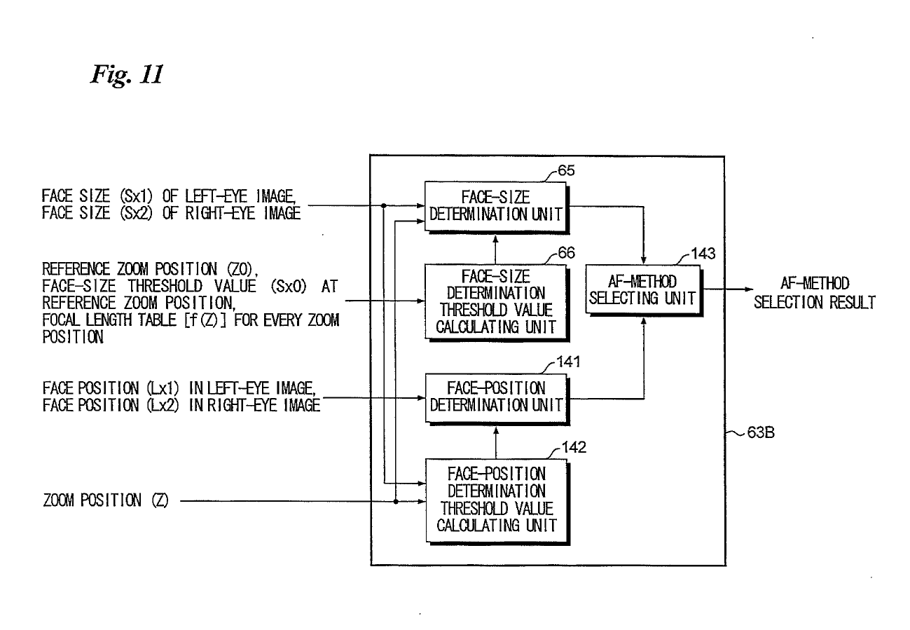

FIGS. 11 to 15 illustrate another embodiment. This embodiment takes face position into consideration as well.

FIG. 11 illustrates the electrical configuration of an AF changeover unit 63B. Items in FIG. 11 identical with those shown in FIG. 6 are designated by like reference characters and need not be described again.

The AF changeover unit 63B includes a face-position determination unit 141, a face-position determination threshold value calculating unit 142 and an AF-method selecting unit 143.

Input to the face-position determination unit 141 is data representing face position Lx1 indicating amount of horizontal offset of the face from the center of the left-eye image and data representing face position Lx2 indicating amount of horizontal offset of the face from the center of the right-eye image. Further, data indicating the zoom position is input to the face-position determination threshold value calculating unit 142.

The face-size determination unit 65 outputs data indicative of a determination result indicating whether the size Sx1 of the face in the left-eye image and the size Sx2 of the face in the right-eye image are both equal to or greater than the face-size comparison threshold value Sxlimit. This data is input to the AF-method selecting unit 143. Further, the face-position determination unit 141 outputs data indicative of a determination result indicating whether the position Lx1 of the face in the left-eye image and the position Lx2 of the face in the right-eye image are both less than the face-position determination threshold value. This data is input to the AF-method selecting unit 143. If the size Sx1 of the face in the left-eye image and the size Sx2 of the face in the right-eye image are both equal to or greater than the face-size comparison threshold value Sxlimit and, moreover, either the position Lx1 of the face in the left-eye image or the position Lx2 of the face in the right-eye image is less than the face-position determination threshold value, then, as mentioned above, focusing control of the left-eye image capture device 10 utilizing the left-eye image is carried out and focusing control of the right-eye image capture device 30 using the right-eye image is carried out.

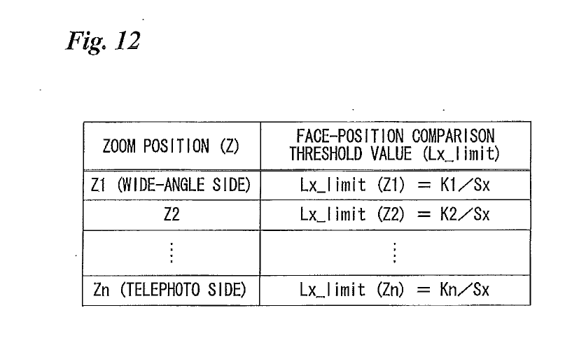

FIG. 12 illustrates the relationship between zoom position and a face-position comparison threshold value Lxlimit (second threshold value).

A face-position comparison threshold value Lxlimit has been decided for every zoom position. The face-position comparison threshold value is found by dividing a face-position determination coefficient Kn, which has been decided in conformance with zoom position, by face size Sx (Sx1 or Sx2). If the face is small, the amount of movement of the face within the viewing angle will have little influence upon the distance difference between the distance from the left-eye image capture device 10 to the subject and the distance from the right-eye image capture device 30 to the subject. The larger the face, the greater the influence. For this reason the face-position comparison threshold value Lxlimit is obtained by dividing the face-position determination coefficient Kn by the size of the face.

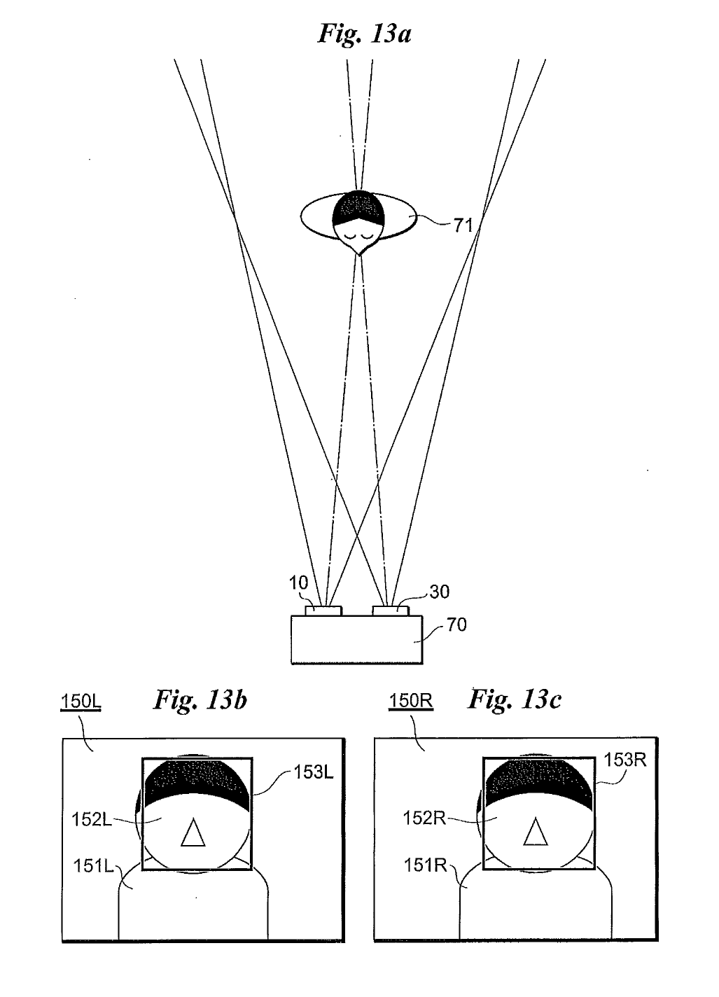

FIG. 13a illustrates the positional relationship between the stereoscopic imaging digital camera 70 and the subject, FIG. 13b an example of a left-eye image obtained by imaging, and FIG. 13c an example of a right-eye image obtained by imaging.

In a case where the subject 71 is in the vicinity of the center of the viewing angle, as shown in FIG. 13a, the distance from the left-eye image capture device 10 to the subject 71 and the distance from the right-eye image capture device 30 to the subject 71 are deemed to be substantially equal.

With reference to FIG. 13b, a left-eye image 150L includes a subject image 151L representing the subject 71. A face frame 153L enclosing a face 152L is being displayed as well.

With reference to FIG. 13c, a right-eye image 150R also includes a subject image 151R representing the subject 71. A face frame 153R enclosing a face 152R is being displayed as well.

The faces 152L and 152R are both being displayed substantially at the centers of the images.

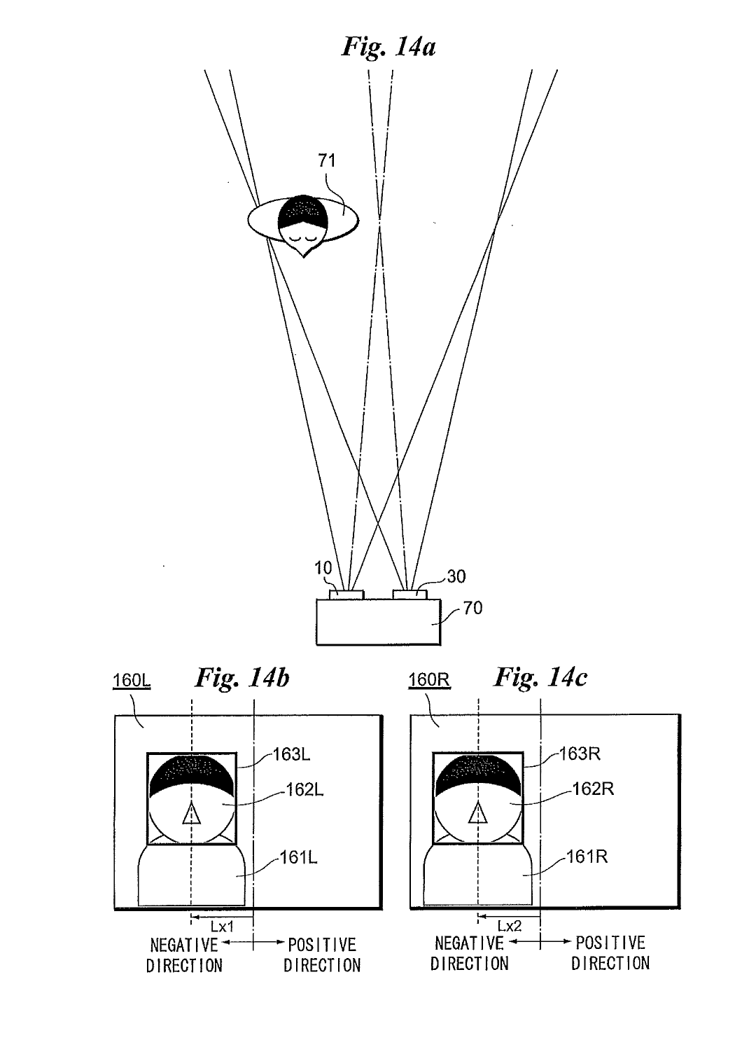

FIG. 14a illustrates the positional relationship between the stereoscopic imaging digital camera 70 and the subject, FIG. 14b an example of a left-eye image obtained by imaging, and FIG. 14c an example of a right-eye image obtained by imaging.

In a case where the subject 71 is at the edge of the viewing angle, as shown in FIG. 14a, the distance from the left-eye image capture device 10 to the subject 71 and the distance from the right-eye image capture device 30 to the subject 71 are not considered to be substantially equal.

With reference to FIG. 14b, a left-eye image 160L includes a subject image 161L representing the subject 71. A face frame 163L enclosing a face 162L is being displayed as well. The face 162L is offset to the left side (negative side) of the left-eye image 160L by a distance Lx1.

With reference to FIG. 14c, a right-eye image 160R includes a subject image 161R representing the subject 71. A face frame 163R enclosing a face 162R is being displayed as well. The face 162R is offset to the left side (negative side) of the right-eye image 160R by a distance Lx2.

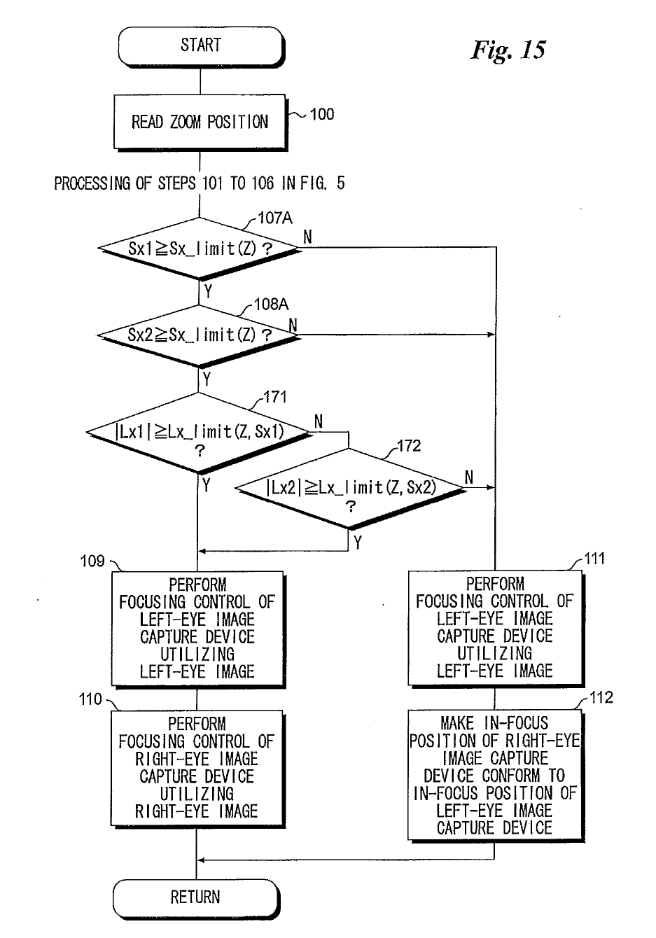

FIG. 15, which is a flowchart illustrating the processing procedure of the stereoscopic imaging digital camera, corresponds to FIG. 10. Processing steps in FIG. 15 identical with those shown in FIG. 10 are designated by like step numbers and need not be described again.

If the size Sx1 of the face in the left-eye image and the size Sx2 of the face in the right-eye image are both equal to or greater than the face-size comparison threshold value Sxlimit (first threshold value) (“YES” at step 108A), as mentioned above, then it is determined whether the absolute value |Lx1| of the amount of horizontal positional offset of the face in the left-eye image is equal to or greater than the face-position comparison threshold value Lxlimit (step 171) and whether the absolute value |Lx2| of the amount of horizontal positional offset of the face in the right-eye image is equal to or greater than the face-position comparison threshold value Lxlimit (second threshold value) (step 172), as mentioned above.

If either the absolute value |Lx1| of the amount of horizontal positional offset of the face in the left-eye image or the absolute value |Lx2| of the amount of horizontal positional offset of the face in the right-eye image is equal to or greater than the face-position comparison threshold value Lxlimit (“YES” at step 171 or 172), this means that the face is offset from the center of the image and, hence, focusing control of the left-eye image capture device 10 utilizing the left-eye image is carried out (step 109) and focusing control of the right-eye image capture device 30 utilizing the right-eye image is carried out (step 110).

If the absolute value |Lx1| of the amount of horizontal positional offset of the face in the left-eye image and the absolute value |Lx2| of the amount of horizontal positional offset of the face in the right-eye image are both less than the face-position comparison threshold value Lxlimit (“NO” at both steps 171 and 172), this means that the face is at the center of the image and, hence, as described above, focusing control of the left-eye image capture device 10 utilizing the left-eye image is carried out (step 111) and focusing control of the right-eye image capture device 30 is carried out to make the in-focus position thereof conform to the in-focus position of the left-eye image capture device 10 (step 112).

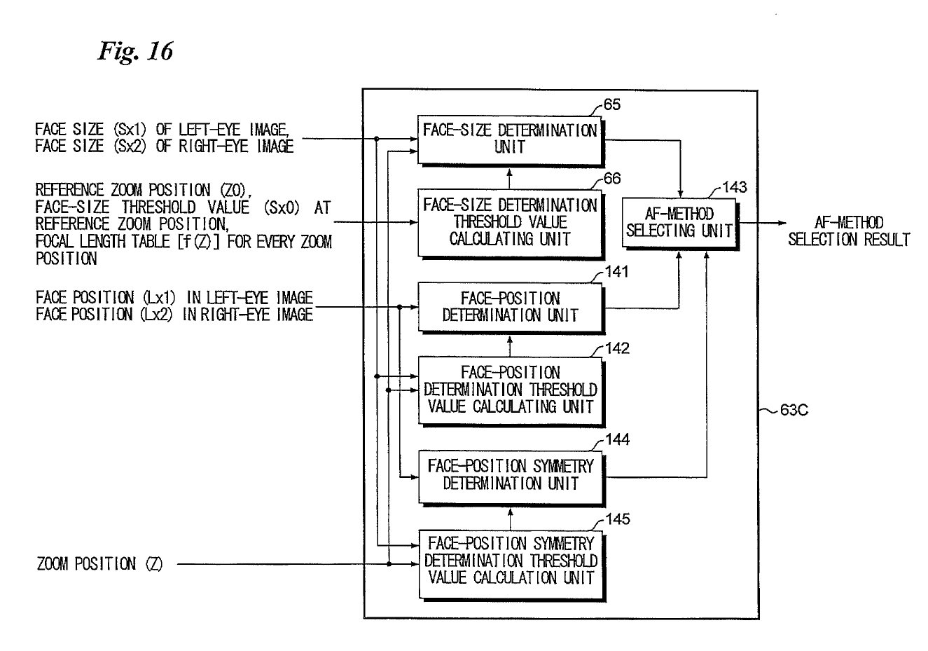

FIGS. 16 to 19 illustrate another embodiment. This embodiment takes symmetry between a face in the left-eye image and a face in the right-eye image into consideration.

FIG. 16 illustrates the electrical configuration of an AF-implementing changeover device 63C. Items in FIG. 16 identical with those shown in FIG. 11 are designated by like reference characters and need not be described again.

The AF-implementing changeover device 63C shown in FIG. 16 includes a face-position symmetry determination unit 144 and a face-position symmetry determination threshold value calculation unit 145 in addition to the units of the device 63B shown in FIG. 11.

Input to the face-position symmetry determination unit 144 is the data representing face position Lx1 in the left-eye image and data representing face position Lx2 in the right-eye image. Data representing zoom position is input to the face-position symmetry determination threshold value calculation unit 145.

If symmetry of the face positions is equal to or greater than a threshold value, which is calculated in the face-position symmetry determination threshold value calculation unit 145, decided for every zoom position, then the symmetry will have a large influence upon the difference between the distance from the left-eye image capture device 10 to the subject and the distance from the right-eye image capture device 30 to the subject. Accordingly, focusing control of the left-eye image capture device 10 utilizing the left-eye image is carried out and focusing control of the right-eye image utilizing the right-eye image is carried out. Conversely, if the symmetry of the face positions is less than the threshold value, which is calculated in the face-position symmetry determination threshold value calculation unit 145, decided for every zoom position, then the symmetry will have a small influence upon the difference between the distance from the left-eye image capture device 10 to the subject and the distance from the right-eye image capture device 30 to the subject. Accordingly, focusing control of the left-eye image capture device 10 utilizing the left-eye image is carried out and focusing control of the right-eye image capture device 30 is carried out to make the in-focus position thereof conform to the in-focus position of the left-eye image capture device 10.

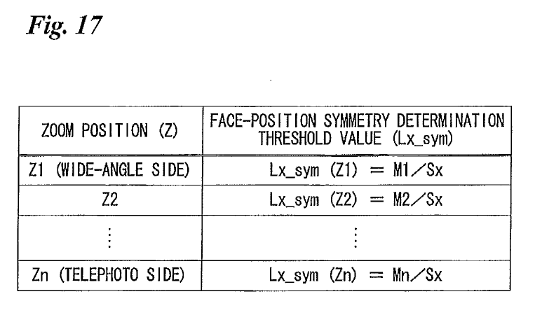

FIG. 17 illustrates the relationship between zoom position and a face-position symmetry determination threshold value Lxsym (third threshold value).

A face-position symmetry determination threshold value Lxsym has been decided for every zoom position. If the face is small, face symmetry will have little influence upon the above-mentioned distance difference even if there is little face symmetry. If the face is large, however, face symmetry will have a large influence upon the above-mentioned distance difference. Accordingly, the value obtained by dividing a face-position symmetry determination coefficient Mn, which is a predetermined coefficient, by face size Sx (Sx1 or Sx2) will be the face-position symmetry determination threshold value Lxsym.

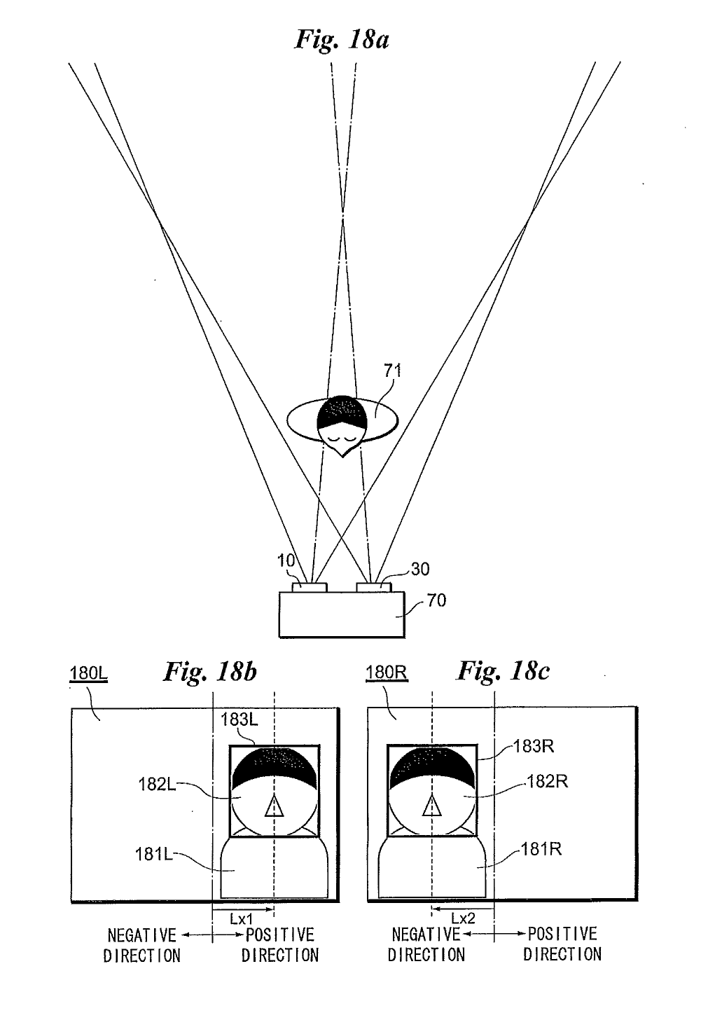

FIG. 18a illustrates the positional relationship between the stereoscopic imaging digital camera 70 and the subject, FIG. 18b an example of a left-eye image obtained by imaging, and FIG. 18c an example of a right-eye image obtained by imaging.

As shown in FIG. 18a, assume that the subject 71 is near the stereoscopic imaging digital camera 70 even if the subject is at the center of the viewing angle. With reference to FIG. 18b, a left-eye image 180L includes a subject image 181L representing the subject 71. A face frame 183L enclosing a face 182L is being displayed as well. The face 182L is offset to the right side (positive side) of the left-eye image 180L by the distance Lx1.

With reference to FIG. 18c, a right-eye image 180R includes a subject image 181R representing the subject 71. A face frame 183R enclosing a face 182R is being displayed as well. The face 182R is offset to the left side (negative side) of the left-eye image 180R by the distance Lx2.

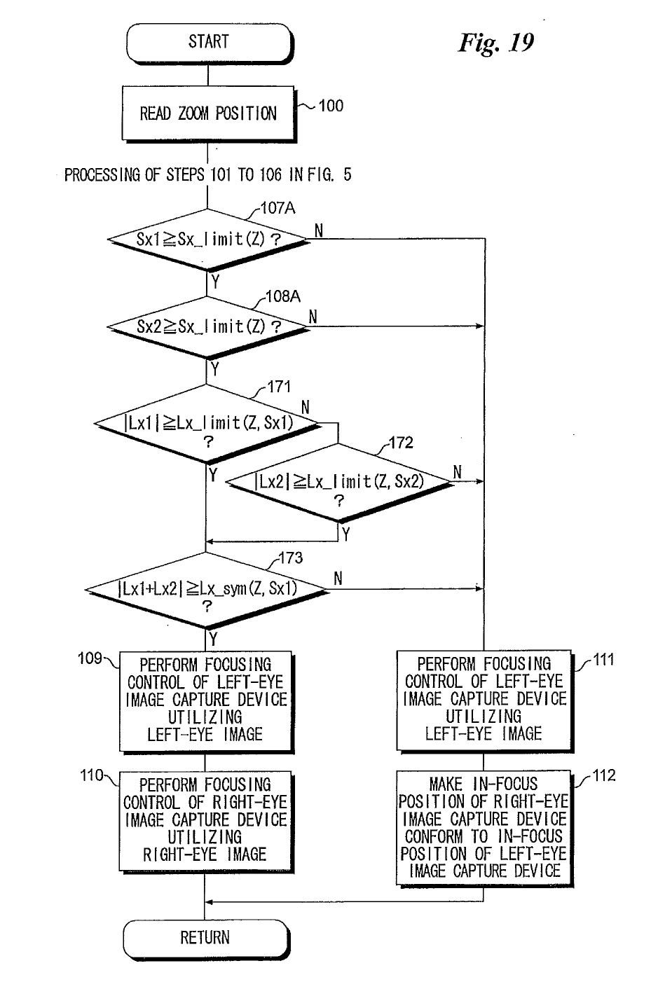

FIG. 19 is a flowchart illustrating the processing procedure of the stereoscopic imaging digital camera. Processing steps in FIG. 19 identical with those shown in FIG. 15 are designated by like step numbers and need not be described again.

Symmetry of the faces is represented by the absolute value |Lx1+Lx2| of the sum of the offsets from the centers of the face images. If this absolute value is equal to or greater than the face-position symmetry determination threshold value Lxsym (third threshold value) (“YES” at step 173), then symmetry will have a large influence upon the distance difference, as mentioned above. Accordingly, focusing control of the left-eye image capture device 10 utilizing the left-eye image is carried out (step 109) and focusing control of the right-eye image utilizing the right-eye image is carried out (step 110).

If absolute value |Lx1+Lx2| of the sum of the offsets from the centers of the face images is less than the face-position symmetry determination threshold value Lxsym (“NO” at step 173), then symmetry will have a small influence upon the distance difference, as mentioned above. Accordingly, as described above, focusing control of the left-eye image capture device 10 utilizing the left-eye image is carried out (step 111) and focusing control of the right-eye image capture device 30 is carried out to make the in-focus position thereof conform to the in-focus position of the left-eye image capture device 10 (step 112).

In the foregoing embodiments, a face is detected. However, what is detected is not limited to a face and it may be arranged so that the above-described processing is executed upon detecting another target image such as the image of a person. Further, in the foregoing embodiments, the face-position comparison threshold value Lxlimit and face-position symmetry determination threshold value Lxsym are decided for every zoom position of the zoom lenses. However, the foregoing embodiments can be implemented without using zoom lenses. In such case one type of face-position comparison threshold value Lxlimit and one type of face-position symmetry determination threshold value Lxsym are decided.

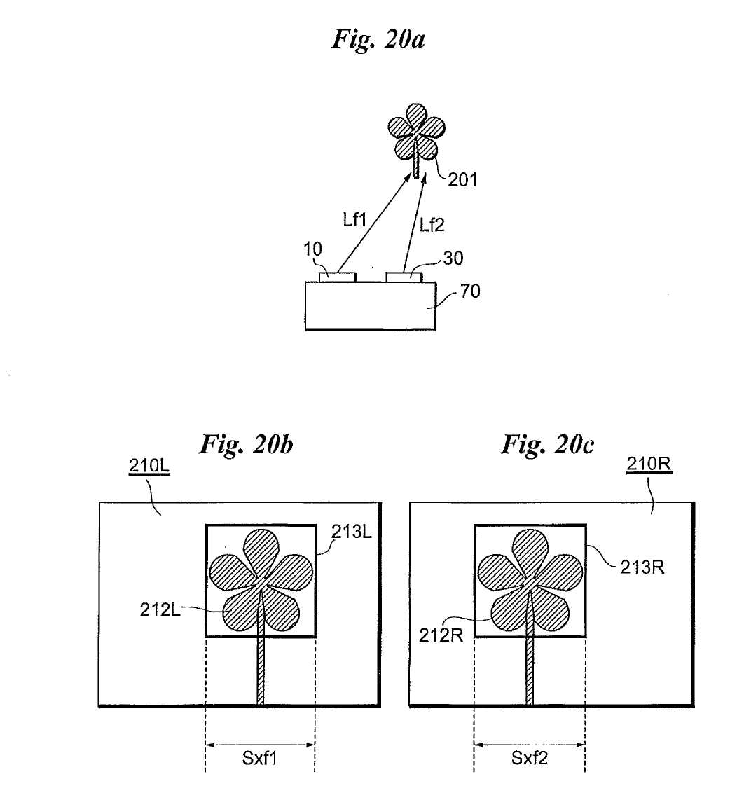

FIGS. 20a, 20b and 20c to FIG. 41 illustrate other embodiments. These embodiments detect a flower instead of a face and carry out focusing control in accordance with the flower size, etc. Since macro photography often is performed for flowers, the effects of these embodiments are particularly great. In a case where an object is a face, as mentioned above, face size does not vary much from person to person. If the object is a flower, however, flower size can range from several millimeters to tens of centimeters and thus varies depending upon the type of flower. For this reason, the value for comparison with flower size makes use of a comparative small value (e.g., on the order of 5 mm). In these embodiments, a stereoscopic imaging digital camera having the electrical configuration shown in FIG. 1 is utilized in a manner similar to that of the above-described embodiments.

FIGS. 20a, 20b and 20c to FIG. 23 correspond to FIGS. 2a, 2b and 2c to FIG. 5 described above.

FIG. 20a illustrates the positional relationship between a subject and the stereoscopic imaging digital camera in a case where a flower (object, physical object) is close to the stereoscopic imaging digital camera, FIG. 20b illustrates a left-eye image obtained by imaging, and FIG. 20c illustrates a right-eye image obtained by imaging.

With reference to FIG. 20a, a flower 201, which is the subject, is at a position in front of and comparatively close to a stereoscopic imaging digital camera 70. The flower 201 is imaged by the left-eye image capture device 10 of the stereoscopic imaging digital camera 70 to thus obtain the left-eye image. Similarly, the flower 201 is imaged by the right-eye image capture device 30 of the stereoscopic imaging digital camera 70 to thus obtain the right-eye image.

FIG. 20b is an example of the left-eye image obtained by imaging.

Left-eye image 210L contains a flower 212L. The flower 212L is detected in the left-eye image 210L by executing flower detection processing. A flower frame 213L is being displayed so as to enclose the flower 212L.

FIG. 20c is an example of the right-eye image obtained by imaging.

Right-eye image 210R contains a flower 212R. The flower 212R is detected in the right-eye image 210R by executing flower detection processing. A flower frame 213R is being displayed so as to enclose the flower 212R.

With reference to FIG. 20a, let the distance from the left-eye image capture device 10 to the flower 201 be Lf1, and let the distance from the right-eye image capture device 30 to the flower 201 be Lf2. If the distances Lf1 and Lf2 are short, the influence of the distance difference |Lf1−Lf2| upon the distance Lf1 or Lf2 is large. Therefore, if focusing control common to both the left-eye image capture device 10 and the right-eye image capture device 30 is carried out using the distance Lf1, the left-eye image obtained by the left-eye image capture device 10 will be brought into focus comparatively accurately, but the right-eye image obtained by the right-eye image capture device 30 will not be brought into focus very accurately. Similarly, if focusing control common to both the left-eye image capture device 10 and the right-eye image capture device 30 is carried out using the distance Lf2, the right-eye image obtained by the right-eye image capture device 30 will be brought into focus comparatively accurately, but the left-eye image obtained by the left-eye image capture device 10 will not be brought into focus very accurately. Accordingly, in this embodiment, if size Sxf1 of the flower 212L detected from the left-eye image 210L and size Sxf2 of the face 212R detected from the right-eye image 210R are both equal to or greater than a first threshold value, then focusing control of the left-eye image capture device 10 is carried out based upon the distance Lf1 from the left-eye image capture device 10 to the flower 201 and, moreover, focusing control of the right-eye image capture device 30 is carried out based upon the distance Lf2 from the right-eye image capture device 30 to the flower. Both the left-eye image and right-eye image are brought into focus comparatively accurately.

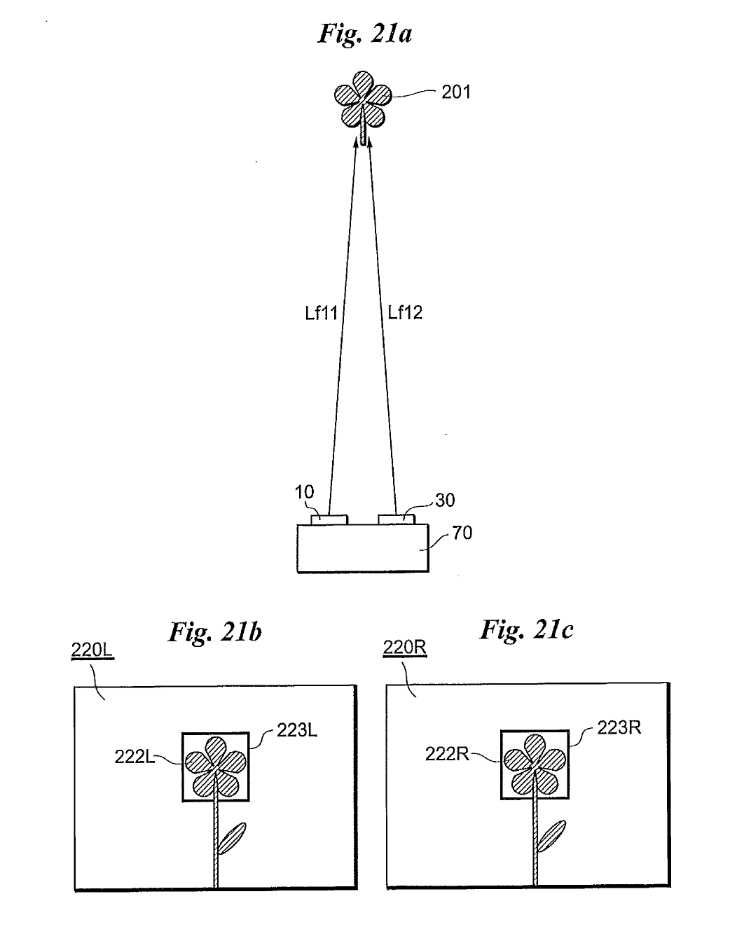

FIG. 21a illustrates the positional relationship between the flower and the stereoscopic imaging digital camera in a case where the flower is far from the stereoscopic imaging digital camera, FIG. 21b illustrates a left-eye image obtained by imaging, and FIG. 21c illustrates a right-eye image obtained by imaging.

With reference to FIG. 21a, the flower 201 is at a position in front of and far from the stereoscopic imaging digital camera 70. The flower 201 is imaged by the left-eye image capture device 10 of the stereoscopic imaging digital camera 70 to thus obtain the left-eye image. Similarly, the flower 201 is imaged by the right-eye image capture device 30 of the stereoscopic imaging digital camera 70 to thus obtain the right-eye image.

FIG. 21b is an example of the left-eye image obtained by imaging.

Left-eye image 220L contains a flower 222L. The flower 222L is detected in the left-eye image 220L by executing face detection processing. A flower frame 223L is being displayed so as to enclose the face flower 222L.

FIG. 21c is an example of the right-eye image obtained by imaging.

Right-eye image 220R contains a flower 222R. The flower 222R is detected in the right-eye image 220R by executing face detection processing. A flower frame 223R is being displayed so as to enclose the face flower 222R.

With reference to FIG. 21a, let the distance from the left-eye image capture device 10 to the flower 201 be Lf11, and let the distance from the right-eye image capture device 30 to the flower 201 be Lf12. If the distances Lf11 and Lf12 are long, the influence of the distance difference |Lf11−Lf12| upon the distance Lf11 or Lf12 is small. Therefore, even if focusing control common to both the left-eye image capture device 10 and the right-eye image capture device 30 is carried out using either the distance Lf11 or the distance Lf12, both the left-eye image and the right-eye image will be brought into focus comparatively accurately. Accordingly, in this embodiment, if either the size of the flower 220L detected from the left-eye image 220L or the size of the flower 220R detected from the right-eye image 220R is smaller than the first threshold value, then focusing control of both the left-eye image capture device 10 and right-eye image capture device 30 is carried out based upon the distance Lf11 from the left-eye image capture device 10 to the flower 201 or the distance Lf12 from the right-eye image capture device 30 to the flower 201.

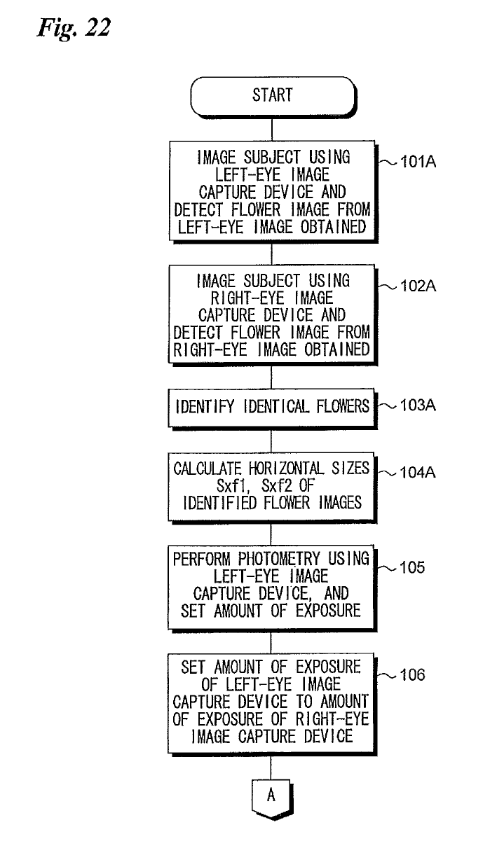

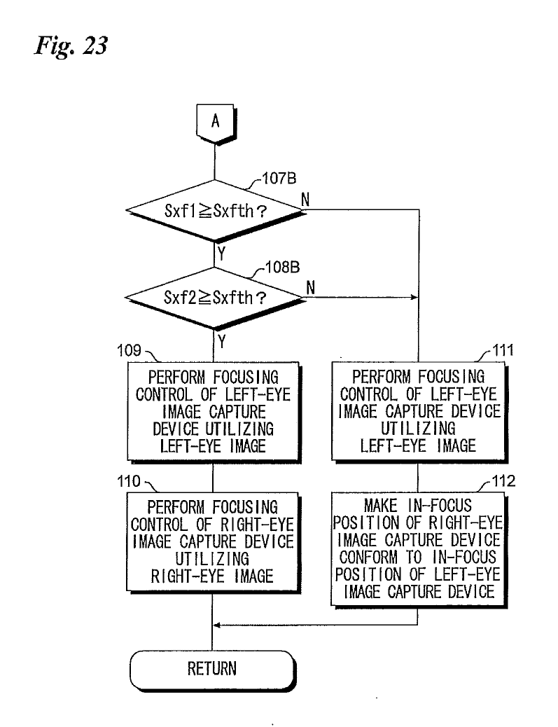

FIGS. 22 and 23, which correspond to FIGS. 4 and 5, are flowcharts illustrating the processing procedure of the stereoscopic imaging digital camera. Processing steps in FIG. 22 or FIG. 23 identical with those shown in FIG. 4 or FIG. 5 are designated by like step numbers and need not be described again.

Assume that the stereoscopic imaging digital camera has been set to the imaging mode (e.g., the macro imaging mode) and that a subject is being imaged periodically.

When the shutter-release button is pressed through the first stage of its stroke, as mentioned above, after such pressing of the button the flower is imaged by the left-eye image capture device 10 and the flower is detected from the left-eye image obtained by imaging (step 101A). It goes without saying that the flower can be detected by template matching or some other method utilizing the color and shape, etc., of the flower. Similarly, the flower is imaged by the right-eye image capture device 30 and the flower is detected from the right-eye image obtained by imaging (step 102A). The same flower is identified between the flower detected from the left-eye image and the flower detected from the right-eye image (step 103A). If an identical flower is not found, focusing control is performed in such a manner that the image center is brought into focus. If multiple identical flowers are found, then one flower is identified based upon whether it is the largest flower or the flower closest to the center position, etc.

Next, the horizontal size Sxf1 of the flower detected from the left-eye image and the horizontal size Sxf2 of the flower detected from the right-eye image are calculated (step 104A).

Furthermore, the amount of exposure of the left-eye image capture device 10 is decided from the left-eye image data obtained from the left-eye image capture device 10 (or from data representing the detected flower), and this decided amount of exposure is set (step 105). Next, the right-eye image capture device 30 is also set in such a manner that an amount of exposure identical with that of the left-eye image capture device 10 will be obtained for this device (step 106).

It is determined whether the size Sxf1 of the flower detected from the left-eye image is equal to or greater than a first threshold value Sxfth (5 mm, for example, as mentioned above) (step 107B). If the size Sxf1 of the flower is equal to or greater than the first threshold value Sxfth (“YES” at step 107B), then it is determined whether the size Sxf2 of the flower detected from the right-eye image is equal to or greater than a first threshold value Sxfth (step 108B). If the size Sxf2 also is equal to or greater than the first threshold value Sxfth (“YES” at step 108B), then it is deemed that the distance to the flower is short. Accordingly, as mentioned above, focusing control of the left-eye image capture device 10 (positioning of the first focusing lens 13) is carried out utilizing the flower detected from the left-eye image (the distance from the left-eye image capture device 10 to the flower; the left-eye image) (step 109). Furthermore, focusing control of the right-eye image capture device 30 (positioning of the second focusing lens 33) is carried out utilizing the flower detected from the right-eye image (the distance from the right-eye image capture device 10 to the flower; the right-eye image) (step 110).

If the size Sxf1 of the flower detected from the left-eye image is smaller than the first threshold value (“NO” at step 107B), or if the size Sxf2 of the flower detected from the right-eye image is smaller than the first threshold value (“NO” at step 108B), then focusing control of the left-eye image capture device 10 (positioning of the first focusing lens 13) is carried out utilizing the flower detected from the left-eye image (the distance from the left-eye image capture device 10 to the flower; the left-eye image) (step 111). Since the distance to the flower is deemed to be long, focusing control can be carried out comparatively accurately even if focusing control of the right-eye image capture device 30 (positioning of the second focusing lens 33) is carried out using the flower detected from the left-eye image. Focusing control of the right-eye image capture device 30 therefore is carried out using the flower detected from the left-eye image. An arrangement may be adopted in which focusing control of the right-eye image capture device 30 is carried out using the flower detected from the right-eye image (the distance from the right-eye image capture device 30 to the subject; the right-eye image) and focusing control of the left-eye image capture device is carried out using the right-eye image.

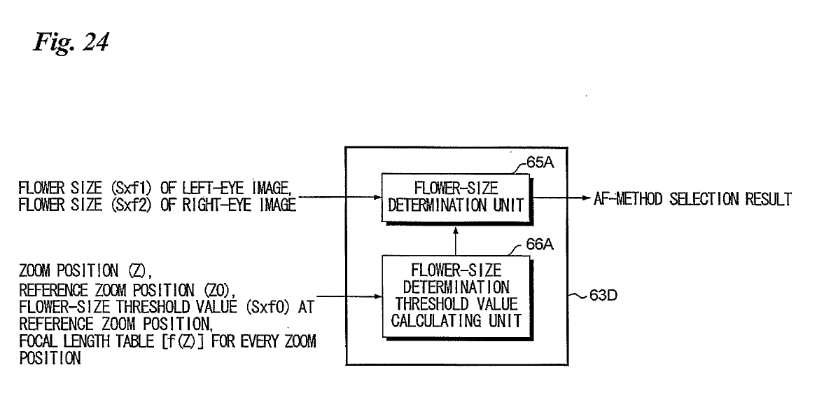

FIGS. 24 to 30 illustrate another embodiment and correspond to the embodiment of FIGS. 6 to 10 described above. This embodiment pertains to a case where zoom lenses are utilized. In the above-described embodiment, the first threshold value is decided based upon face size. In this embodiment, however, the threshold value is decided upon referring to zoom position.

FIG. 24 illustrates the electrical configuration of an AF-implementing changeover device 63D.

The AF-implementing changeover unit 63D includes a flower-size determination unit 65A and a flower-size determination threshold value calculating unit 66A. Input to the flower-size determination unit 65A is data representing the size Sxf1 of the flower detected from the left-eye image and data representing the size Sxf2 of the flower detected from the right-eye image. Input to the flower-size determination threshold value calculating unit 66A are data representing zoom position Z of the first zoom lens 12, reference zoom position (either zoom lens position) Z0, flower-size threshold value Sxf0 at the reference zoom position, and focal length table f(Z) for every zoom position. A flower-size comparison threshold value is calculated in the flower-size determination threshold value calculating unit 66A based upon these items of input data. Data representing the calculated threshold value is input to the flower-size determination unit 65A.

If both of the flower sizes Sxf1 and Sxf2 are equal to or greater than the decided threshold value, then the flower-size determination unit 65A outputs data indicating an AF-method selection result according to which, as described above, focusing control of the left-eye image capture device 10 (positioning of the first focusing lens 13) is carried out utilizing the left-eye image (distance from the left-eye image capture device 10 to the flower) and, moreover, focusing control of the right-eye image capture device 30 (positioning of the second focusing lens 33) is carried out utilizing the right-eye image (distance from the right-eye image capture device 10 to the flower).

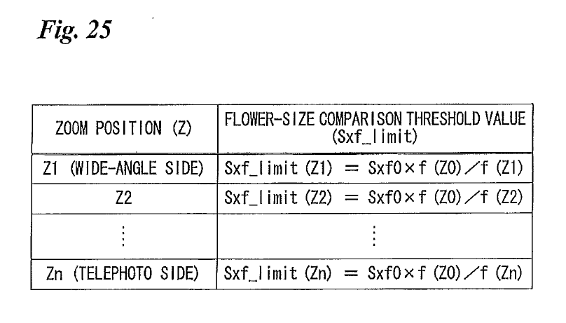

FIG. 25 illustrates the relationship between zoom position and flower-size comparison threshold value Sxflimit (first threshold value). FIG. 25 corresponds to FIG. 7.

A flower-size comparison threshold value Sxflimit has been decided in accordance with each zoom position Z. The relationship table shown in FIG. 25 can be stored in the above-mentioned flower-size determination threshold value calculating unit 63D beforehand. The threshold value is calculated merely by inputting the zoom position Z to the flower-size determination threshold value calculating unit 66A.

It should be noted that in a case where distance d from the stereoscopic imaging digital camera 70 to the subject is the AF changeover point, Sxf0=Sxd×d/f (Z0) holds, Sxd is the reference zoom position Z0, and flower size is the size (width in the horizontal direction) of the flower when the distance to the subject is d.

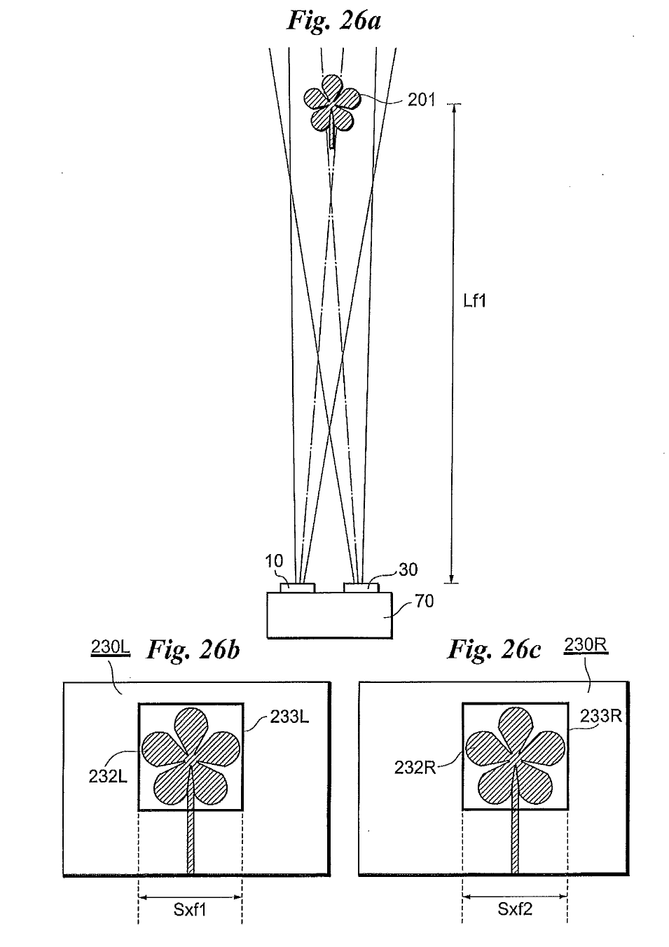

FIG. 26a, which corresponds to FIG. 8a, illustrates the positional relationship between the stereoscopic imaging digital camera and the subject when the flower is at a comparatively far location in a case where the focal length is long (the setting is on the telephoto side). FIG. 26b is an example of a left-eye image obtained by imaging, and FIG. 26c an example of a right-eye image obtained by imaging.

With reference to FIG. 26a, the subject flower 201 is in front of and at a distance Lf1 from the stereoscopic imaging digital camera 70. Assume that both the zoom lens 12 of the left-eye image capture device 10 and the zoom lens 32 of the right-eye image capture device 30 have been set at telephoto zoom positions.

With reference to FIG. 26b, a left-eye image 230L is obtained by the left-eye image capture device 10. The left-eye image 230L includes a flower 232L, which is enclosed by a flower frame 233L.

With reference to FIG. 26c, a right-eye image 230R is obtained by the right-eye image capture device 30. The right-eye image 230R also includes a flower 232R, which is enclosed by a flower frame 233R.

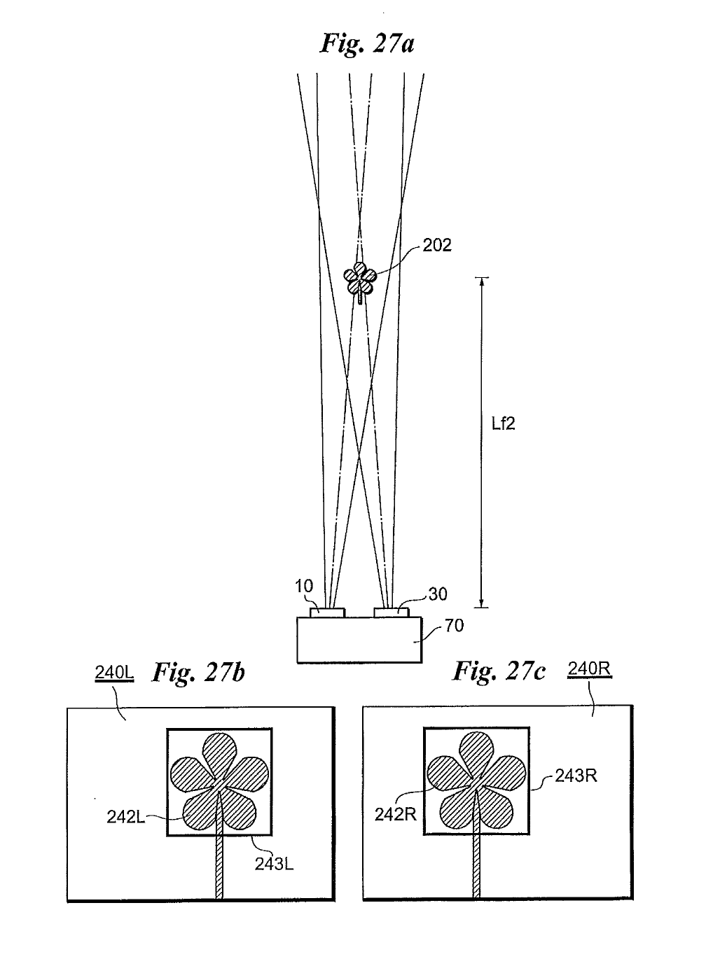

FIG. 27a illustrates the positional relationship between the stereoscopic imaging digital camera and the subject when the flower is at a comparatively nearby location in a case where the focal length is long (the setting is on the telephoto side). FIG. 27b is an example of a left-eye image obtained by imaging, and FIG. 27c an example of a right-eye image obtained by imaging.

With reference to FIG. 27a, a flower 202 smaller than the flower 201 is in front of and at the distance Lf2 (Lf1<Lf2) from the stereoscopic imaging digital camera 70. Assume that both the zoom lens 12 of the left-eye image capture device 10 and the zoom lens 32 of the right-eye image capture device 30 have been set at telephoto zoom positions.

With reference to FIG. 27b, a left-eye image 240L is obtained by the left-eye image capture device 10. The left-eye image 240L includes a flower 242L, which is enclosed by a flower frame 243L.

With reference to FIG. 27c, a right-eye image 240R is obtained by the right-eye image capture device 30. The right-eye image 240R also includes a flower 242R, which is enclosed by a flower frame 243R.

As will be appreciated when FIGS. 26a, 26b and 26c are compared with FIGS. 27a, 27b and 27c, the proportion of the flower relative to the captured image increases when a long focal length is set (namely when the setting is on the telephoto side). Since the proportion of the flower increases, it is judged that the flower is nearby.

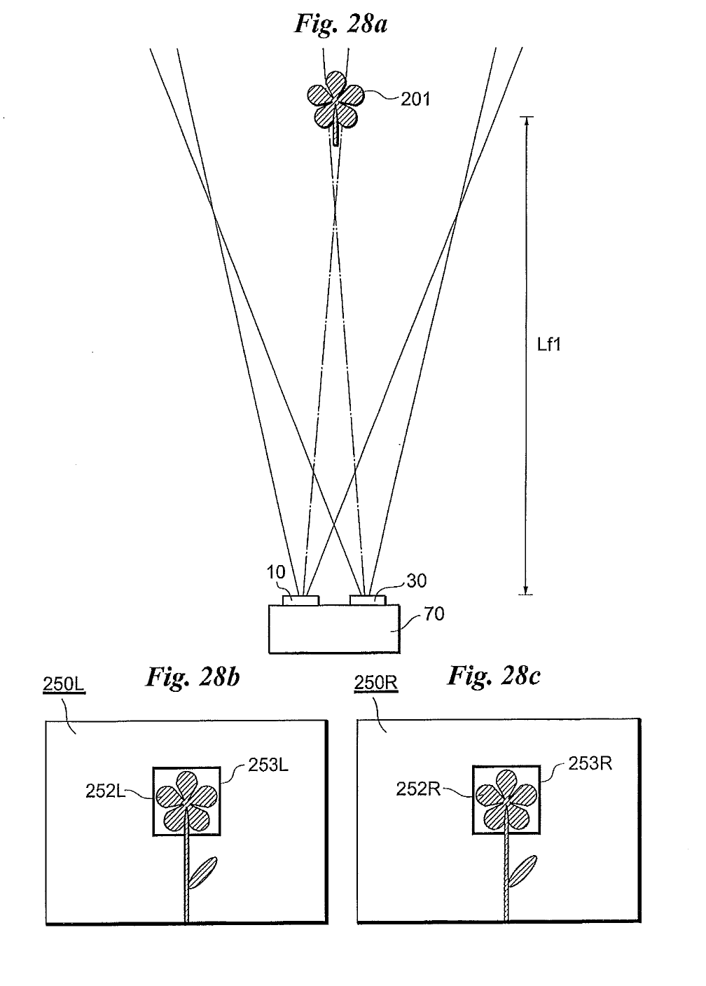

FIG. 28a, which corresponds to FIG. 9a, illustrates the positional relationship between the stereoscopic imaging digital camera and the subject when the flower is far away in a case where the focal length is short (the setting is on the wide-angle side). FIG. 28b is an example of a left-eye image obtained by imaging, and FIG. 28c an example of a right-eye image obtained by imaging.

With reference to FIG. 28a, the flower 201 is in front of and at the distance Lf1 from the stereoscopic imaging digital camera 70. Both the zoom lens 12 of the left-eye image capture device 10 and the zoom lens 32 of the right-eye image capture device 30 have been set at wide-angle zoom positions.

With reference to FIG. 28b, a left-eye image 250L is obtained by the left-eye image capture device 10. The left-eye image 250L includes a flower 252L, which is enclosed by a flower frame 253L.

With reference to FIG. 28c, a right-eye image 250R is obtained by the right-eye image capture device 30. The right-eye image 250R also includes a flower 252R, which is enclosed by a flower frame 253R.

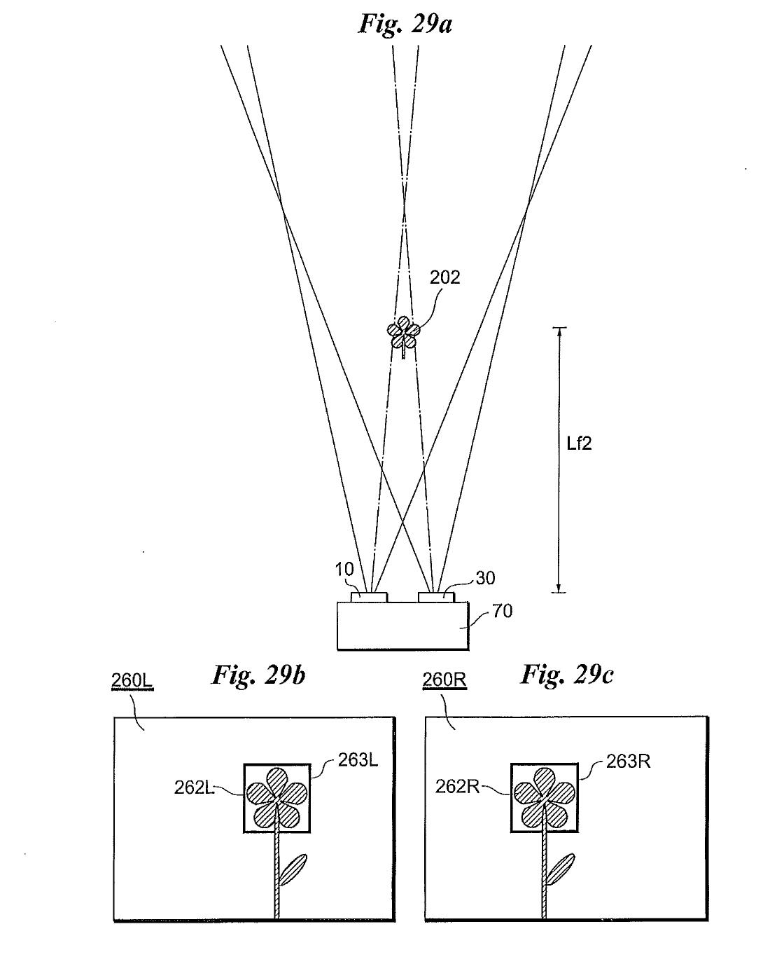

FIG. 29a illustrates the positional relationship between the stereoscopic imaging digital camera and the subject when the flower is nearby in a case where the focal length is short (the setting is on the wide-angle side). FIG. 29b is an example of a left-eye image obtained by imaging, and FIG. 29c an example of a right-eye image obtained by imaging.

With reference to FIG. 29a, the comparatively small flower 202 is in front of and at the distance Lf2 from the stereoscopic imaging digital camera 70. Both the zoom lens 12 of the left-eye image capture device 10 and the zoom lens 32 of the right-eye image capture device 30 have been set at wide-angle zoom positions.

With reference to FIG. 29b, a left-eye image 260L is obtained by the left-eye image capture device 10. The left-eye image 260L includes a flower 262L, which is enclosed by a flower frame 263L.

With reference to FIG. 29c, a right-eye image 260R is obtained by the right-eye image capture device 30. The right-eye image 260R also includes a flower 262R, which is enclosed by a flower frame 263R.

As will be appreciated when reference is had to FIGS. 26a, 26b and 26c to FIGS. 29a, 29b and 29c, if the zoom lenses are set to the wide-angle side, the proportion of the flower in the image obtained by shooting decreases even though the position of the flower does not change. In this embodiment, therefore, a threshold value conforming to zoom position is utilized, as mentioned above.

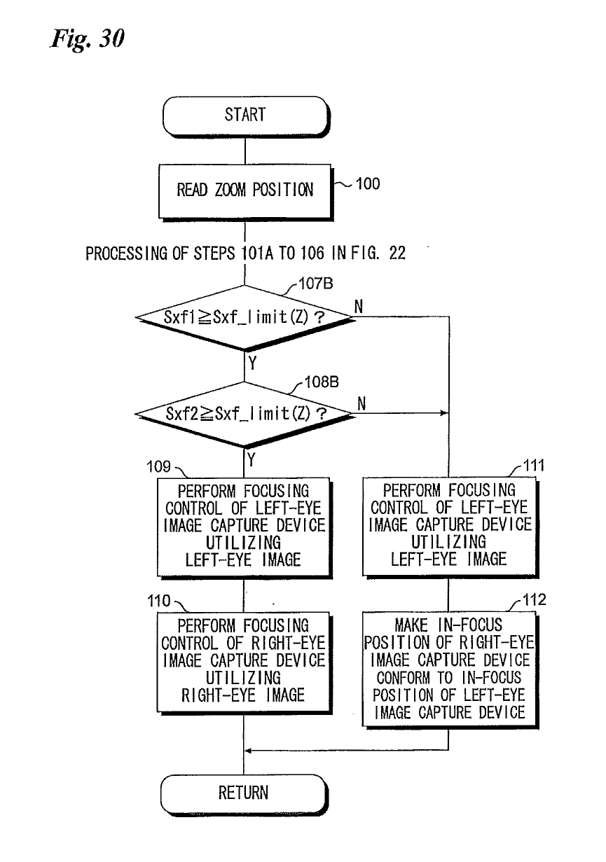

FIG. 30 is a flowchart illustrating the processing procedure of the stereoscopic imaging digital camera. FIG. 30 corresponds to FIG. 10, and processing steps in FIG. 30 identical with those shown in FIGS. 10 and 22 are designated by like step numbers and need not be described again.

When the shutter-release button is pressed through the first stage of its stroke, the zoom position (which may be the position of the first zoom lens 12 or second zoom lens 32 because the lenses 12 and 32 are operatively associated) is read (step 100). Thereafter, as described above, processing is executed for calculating the size Sxf1 of the flower in the left-eye image and the size Sxf2 of the flower in the right-eye image (steps 101A to 106 in FIG. 22).

It is determined whether the size Sxf1 of the flower in the left-eye image is equal to or greater than the flower-size comparison threshold value Sxflimit (first threshold value) that conforms to the read zoom position (step 107B). If the size Sxf1 of the flower is equal to or greater than the flower-size comparison threshold value Sxflimit (“YES” at step 107B), then it is determined whether the size Sxf2 of the flower in the right-eye image is equal to or greater than the flower-size comparison threshold value Sxflimit that conforms to the read zoom position (step 108B). If the size Sxf2 also is equal to or greater than the flower-size comparison threshold value Sxflimit (“YES” at step 108B), then it is deemed that the distance from the stereoscopic imaging digital camera 70 to the subject is comparatively short and, as described above, focusing control of the left-eye image capture device 10 utilizing the flower detected from the left-eye image is carried out (step 109) and focusing control of the right-eye image capture device 30 utilizing the flower detected from the right-eye image is carried out (step 110).

If the size Sxf1 of the flower in the left-eye image is smaller than the flower-size comparison threshold value Sxflimit (“NO” at step 107B), or if the size Sxf2 of the flower detected from the right-eye image is smaller than the flower-size comparison threshold value Sxflimit (“NO” at step 108B), then it is deemed that the distance from the stereoscopic imaging digital camera 70 to the subject is comparatively long and, as described above, focusing control of the left-eye image capture device 10 utilizing the flower detected from the left-eye image is carried out (step 111) and focusing control of the right-eye image capture device 30 is carried out to make the in-focus position thereof conform to the in-focus position of the left-eye image capture device 10 (step 112).

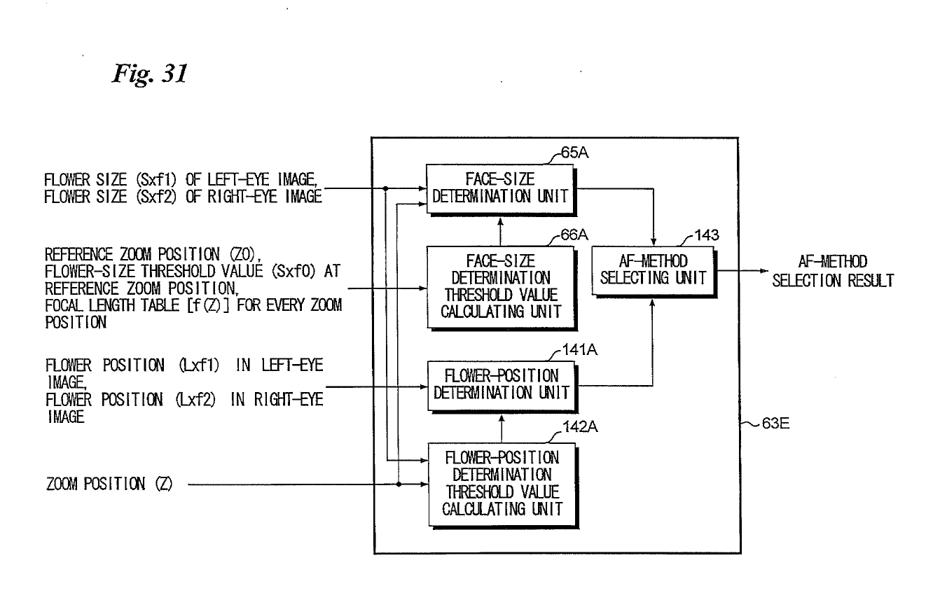

FIGS. 31 to 37 illustrate another embodiment and correspond to the embodiment shown in FIGS. 11 to 15 described above. This embodiment takes flower position at a wide angle as well into consideration.

FIG. 31 is a block diagram illustrating the electrical configuration of an AF changeover device 63E. Items in FIG. 31 identical with those shown in FIG. 24 are designated by like reference characters and need not be described again.

The AF changeover device 63E includes a flower-position determination unit 141A, a flower-position determination threshold value calculating unit 142A and an AF-method selecting unit 143.

Input to the flower-position determination unit 141A is data representing flower position Lxf1 indicating amount of horizontal offset of the flower from the center of the left-eye image and data representing flower position Lxf2 indicating amount of horizontal offset of the flower from the center of the right-eye image. Further, data indicating the zoom position is input to the flower-position determination threshold value calculating unit 142A.

The face-size determination unit 65A outputs data indicative of a determination result indicating whether the size Sxf1 of the flower in the left-eye image and the size Sxf2 of the flower in the right-eye image are both equal to or greater than the flower-size comparison threshold value Sxflimit. This data is input to the AF-method selecting unit 143. Further, the flower-position determination unit 141A outputs data indicative of a determination result indicating whether the position Lxf1 of the flower in the left-eye image and the position Lxf2 of the flower in the right-eye image are both less than the flower-position determination threshold value. This data is input to the AF-method selecting unit 143. If the size Sxf1 of the flower in the left-eye image and the size Sxf2 of the flower in the right-eye image are both equal to or greater than the flower-size comparison threshold value Sxflimit and, moreover, either the position Lxf1 of the flower in the left-eye image or the position Lxf2 of the flower in the right-eye image is less than the flower-position determination threshold value, then, as mentioned above, focusing control of the left-eye image capture device 10 utilizing the left-eye image is carried out and focusing control of the right-eye image capture device 30 using the right-eye image is carried out.

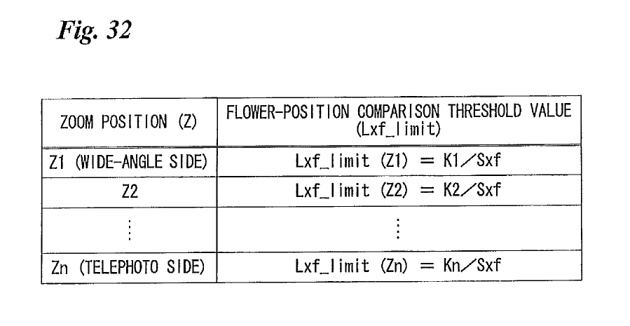

FIG. 32, which corresponds to FIG. 12, illustrates the relationship between zoom position and a flower-position comparison threshold value Lxflimit (second threshold value).

A flower-position comparison threshold value Lxflimit has been decided for every zoom position. The flower-position comparison threshold value is found by dividing a flower-position determination coefficient Kn, which has been decided in conformance with zoom position, by flower size Sxf (Sxf1 or Sxf2). If the flower is small, the amount of movement of the flower within the viewing angle will have little influence upon the distance difference between the distance from the left-eye image capture device 10 to the subject and the distance from the right-eye image capture device 30 to the subject. The larger the flower, the greater the influence. For this reason the flower-position comparison threshold value Lxflimit is obtained by dividing the flower-position determination coefficient Kn by the size of the flower.

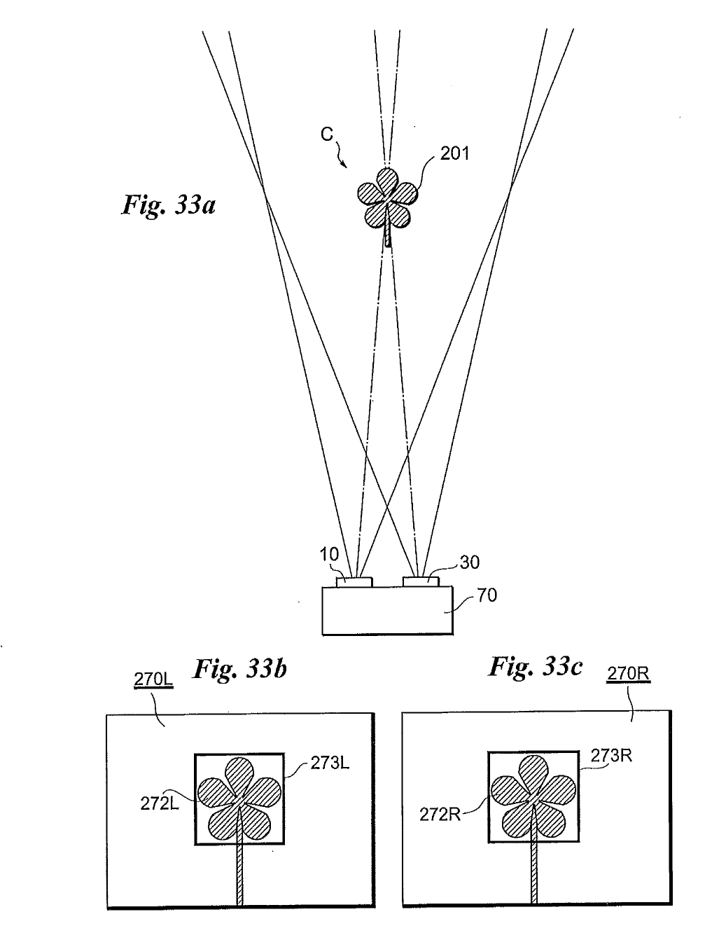

FIG. 33a illustrates the positional relationship between the stereoscopic imaging digital camera 70 and the subject in a case where the comparatively large flower 201 is in the vicinity of the center of the viewing angle. FIG. 33b is an example of a left-eye image obtained by imaging, and FIG. 33c is an example of a right-eye image obtained by imaging.

In a case where the flower 201 is in the vicinity of the center of the viewing angle, as shown in FIG. 33a, the distance from the left-eye image capture device 10 to the flower 201 and the distance from the right-eye image capture device 30 to the flower 201 are deemed to be substantially equal. In a case where the comparatively large flower 201 is imaged, imaging is performed with the flower 201 positioned in the vicinity of the intersection C between the optic axis of the left-eye image capture device 10 and the optic axis of the right-eye image capture device 30 (namely at the cross point of the optic axis, e.g., a distance of 2m from the camera 70).

With reference to FIG. 33b, a left-eye image 270L includes a flower 272L. A flower frame 273L is being displayed as well.

With reference to FIG. 33c, a right-eye image 270R includes a flower 272R. A flower frame 273R enclosing the flower 272R is being displayed as well.

The flowers 272L and 272R are both being displayed substantially at the centers of the images.

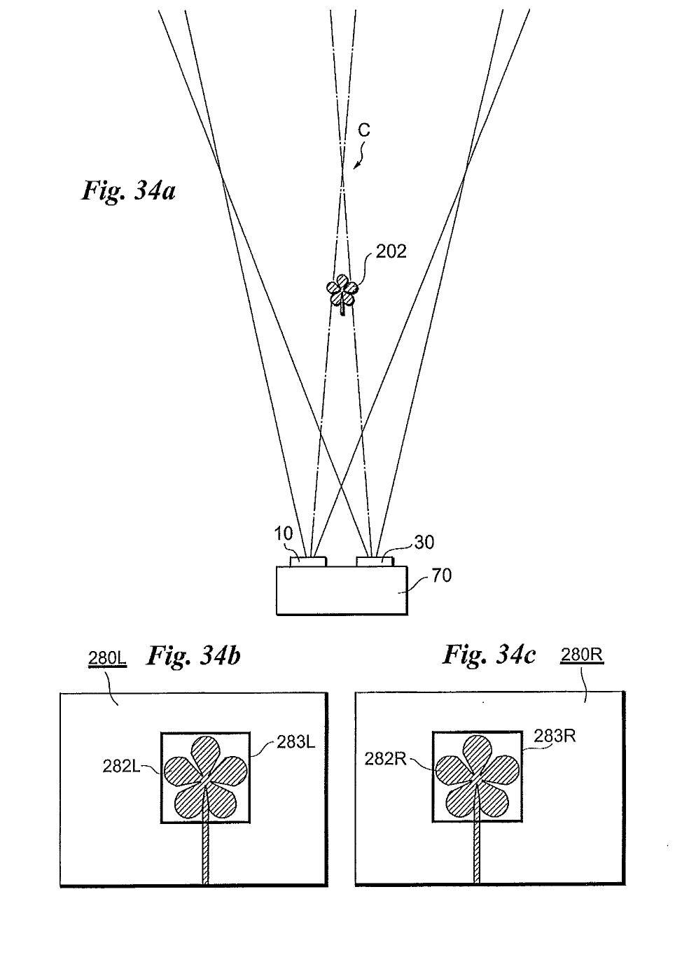

FIG. 34a illustrates the positional relationship between the stereoscopic imaging digital camera 70 and the subject in a case where the comparatively small flower 202 is in the vicinity of the center of the viewing angle. FIG. 34b is an example of a left-eye image obtained by imaging, and FIG. 34c is an example of a right-eye image obtained by imaging.

In a case where the comparatively small flower 202 is imaged, often imaging is performed with the flower spaced away from the cross point C of the optic axes, as shown in FIG. 34a, unlike the case where a comparatively large flower is imaged.

With reference to FIG. 34b, a left-eye image 280L includes a flower 282L. A flower frame 283L is being displayed as well.

With reference to FIG. 34c, a right-eye image 280R includes a flower 282R. A flower frame 283R enclosing the flower 282R is being displayed as well.

The flowers 282L and 282R are both being displayed substantially at the centers of the images.

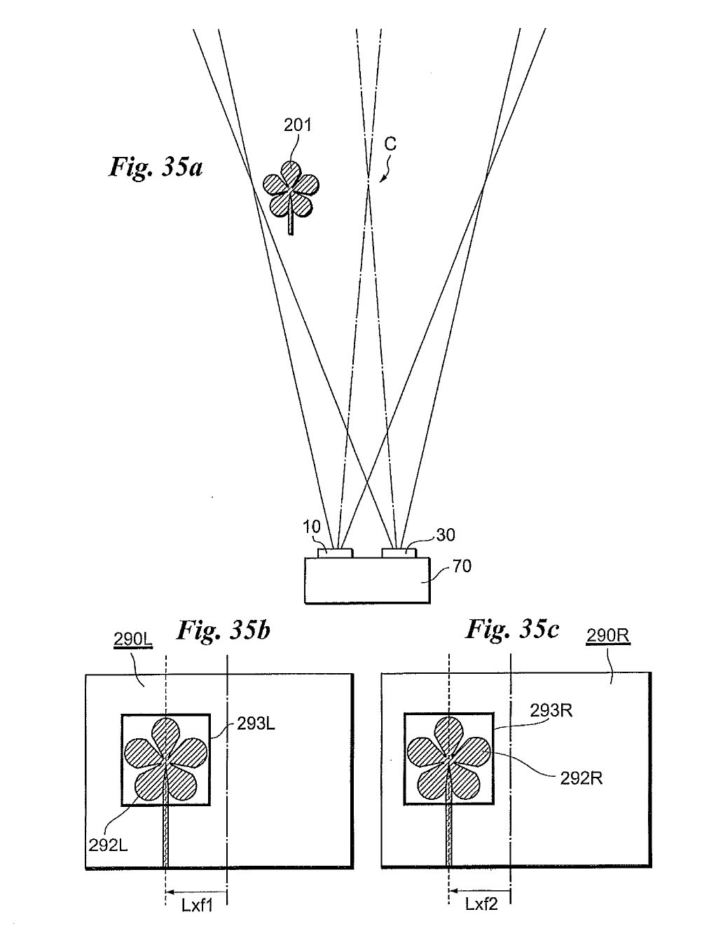

FIG. 35a illustrates the positional relationship between the stereoscopic imaging digital camera 70 and the subject in a case where the comparatively large flower 201 is imaged. Unlike what is shown in FIG. 33a, the flower 201 is situated at the edge (periphery) of the viewing angle.

With reference to FIG. 35b, a left-eye image 290L includes a flower 292L. A flower frame 293L enclosing the flower 292L is being displayed as well. The flower 292L is offset sideways to the left (negative side) of the center of the left-eye image 290L by distance Lxf1.

With reference to FIG. 35c, a right-eye image 290R includes a flower 292R. A flower frame 293R enclosing the flower 292R is being displayed as well. The flower 292R is offset sideways to the left (negative side) of the center of the right-eye image 290R by distance Lxf2.

In a case where the comparatively large flower is imaged, imaging is performed with the flower positioned in the vicinity of the cross point C of the optic axes, as mentioned above. Therefore, the flowers are offset sideways from the centers of the images together in the same direction by the positional offset Lxf1 of flower 292L included in the left-eye image 290L and by the positional offset Lxf2 of flower 292R included in the right-eye image 290R.

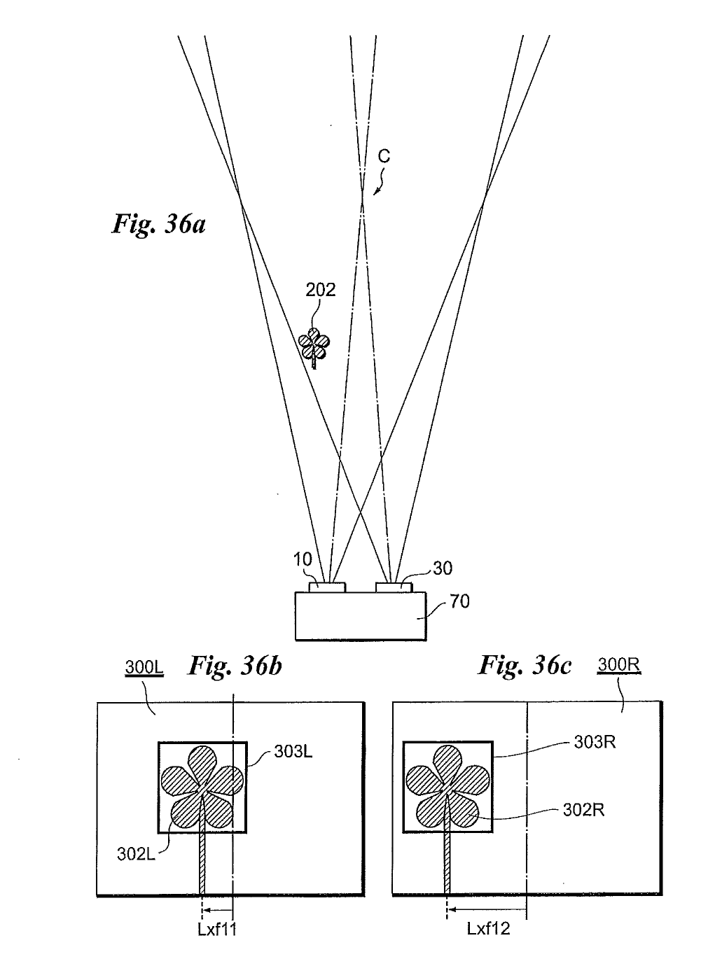

FIG. 36a illustrates the positional relationship between the stereoscopic imaging digital camera 70 and the subject in a case where the comparatively small flower 202 is imaged. Here the flower 202 is situated at the edge (periphery) of the viewing angle.

With reference to FIG. 36b, a left-eye image 300L includes a flower 302L. A flower frame 303L enclosing the flower 302L is being displayed as well. The flower 302L is offset sideways to the left (negative side) of the center of the left-eye image 300L by distance Lxf11.

With reference to FIG. 36c, a right-eye image 300R includes a flower 302R. A flower frame 303R enclosing the flower 302R is being displayed as well. The flower 302R is offset sideways to the left (negative side) of the center of the right-eye image 300R by distance Lxf12.

In a case where the comparatively small flower is imaged, often imaging is performed with the flower positioned at a position spaced away from the cross point C of the optic axes, as mentioned above. Therefore, the positional offset Lxf11 of flower 302L included in the left-eye image 300L and the positional offset Lxf12 of flower 302R included in the right-eye image 300R are amounts of offset that are comparatively different.

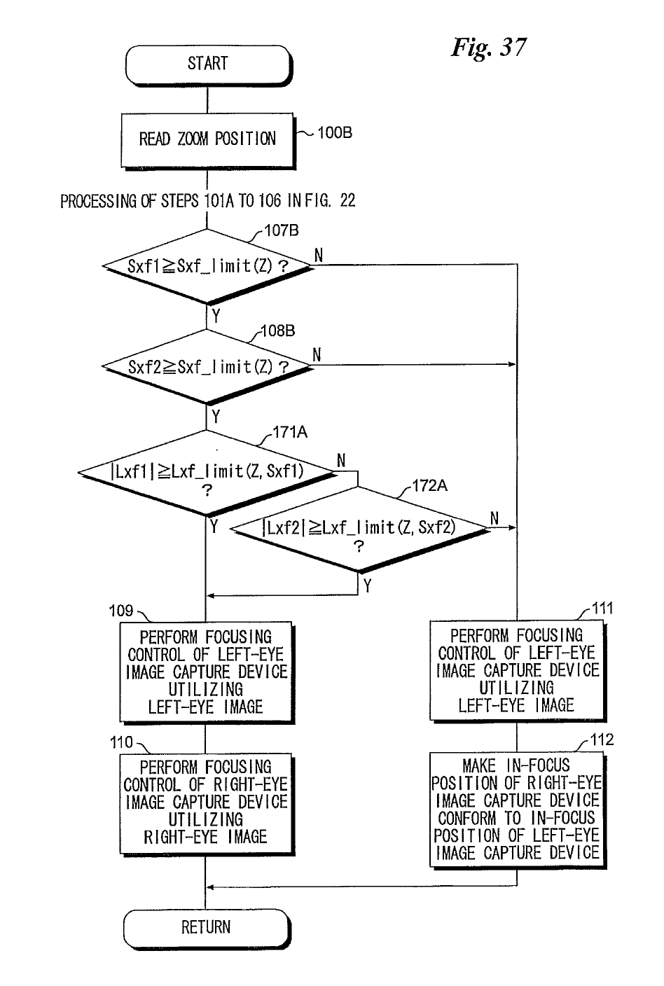

FIG. 37, which corresponds to FIGS. 10 and 15, is a flowchart illustrating the processing procedure of the stereoscopic imaging digital camera. Processing steps in FIG. 37 identical with those shown in FIGS. 10 and 15 are designated by like step numbers and need not be described again.

If the size Sxf1 of the flower in the left-eye image and the size Sxf2 of the flower in the right-eye image are both equal to or greater than the flower-size comparison threshold value Sxflimit (first threshold value) (“YES” at step 108B), as mentioned above, then it is determined whether the absolute value |Lxf1| of the amount of horizontal positional offset of the flower in the left-eye image is equal to or greater than the flower-position comparison threshold value Lxflimit (step 171A) and whether the absolute value |Lxf2| of the amount of horizontal positional offset of the flower in the right-eye image is equal to or greater than the flower-position comparison threshold value Lxflimit (second threshold value) (step 172A), as mentioned above.

If either the absolute value |Lxf1| of the amount of horizontal positional offset of the flower in the left-eye image or the absolute value |Lxf2| of the amount of horizontal positional offset of the flower in the right-eye image is equal to or greater than the flower-position comparison threshold value Lxflimit (“YES” at step 171A or 172A), this means that the flower is offset from the center of the image and, hence, focusing control of the left-eye image capture device 10 utilizing the left-eye image is carried out (step 109) and focusing control of the right-eye image capture device 30 utilizing the right-eye image is carried out (step 110).

If the absolute value |Lxf1| of the amount of horizontal positional offset of the flower in the left-eye image and the absolute value |Lxf2| of the amount of horizontal positional offset of the flower in the right-eye image are both less than the flower-position comparison threshold value Lxflimit (“NO” at both steps 171A and 172A), this means that the flower is at the center of the image and, hence, as described above, focusing control of the left-eye image capture device 10 utilizing the left-eye image is carried out (step 111) and focusing control of the right-eye image capture device 30 is carried out to make the in-focus position thereof conform to the in-focus position of the left-eye image capture device 10 (step 112).

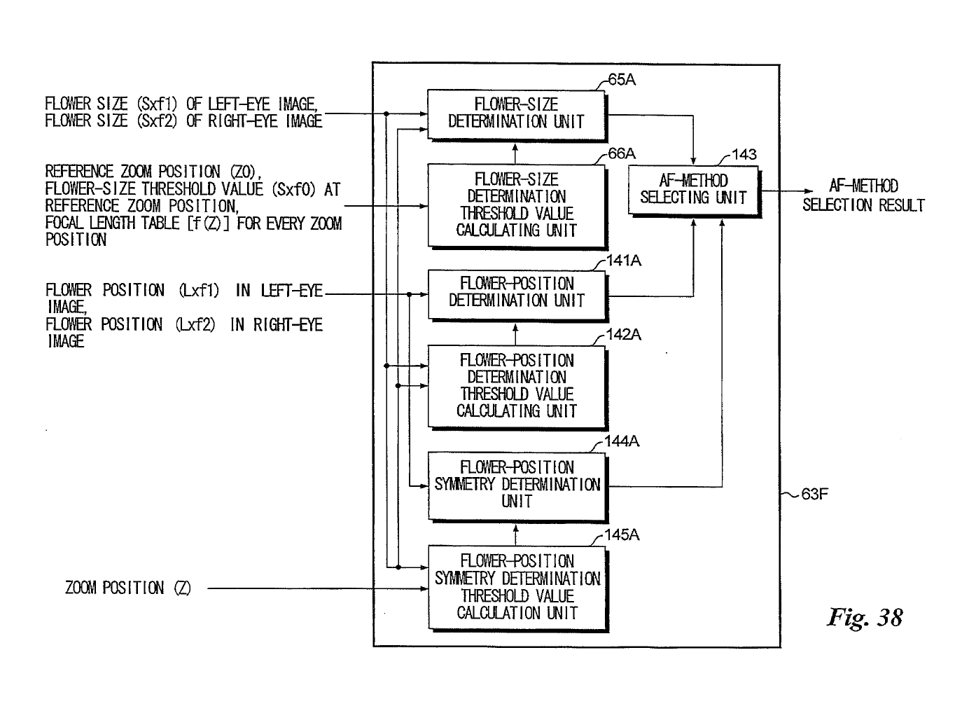

FIGS. 38 to 41 illustrate a further another embodiment and correspond to the embodiment shown in FIGS. 16 to 19. This embodiment takes symmetry between a flower in the left-eye image and a flower in the right-eye image into consideration.

FIG. 38, which corresponds to FIG. 16, illustrates the electrical configuration of an AF-implementing changeover device 63F. Items in FIG. 38 identical with those shown in FIG. 31 are designated by like reference characters and need not be described again.

The AF-implementing changeover device 63F shown in FIG. 38 includes a flower-position symmetry determination unit 144A and a flower-position symmetry determination threshold value calculation unit 145A.

Input to the flower-position symmetry determination unit 144A is the data representing flower position Lxf1 in the left-eye image and data representing flower position Lxf2 in the right-eye image. Data representing zoom position is input to the flower-position symmetry determination threshold value calculation unit 145A.

If symmetry of the flower positions is equal to or greater than a threshold value, which is calculated in the flower-position symmetry determination threshold value calculation unit 145A, decided for every zoom position, then the symmetry will have a large influence upon the difference between the distance from the left-eye image capture device 10 to the subject and the distance from the right-eye image capture device 30 to the subject. Accordingly, focusing control of the left-eye image capture device 10 utilizing the left-eye image is carried out and focusing control of the right-eye image utilizing the right-eye image is carried out. Conversely, if the symmetry of the flower positions is less than the threshold value, which is calculated in the flower-position symmetry determination threshold value calculation unit 145, decided for every zoom position, then the symmetry will have a small influence upon the difference between the distance from the left-eye image capture device 10 to the subject and the distance from the right-eye image capture device 30 to the subject. Accordingly, focusing control of the left-eye image capture device 10 utilizing the left-eye image is carried out and focusing control of the right-eye image capture device 30 is carried out to make the in-focus position thereof conform to the in-focus position of the left-eye image capture device 10.

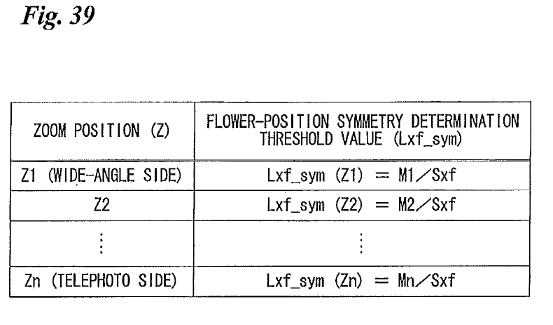

FIG. 39, which corresponds to FIG. 17, illustrates the relationship between zoom position and a flower-position symmetry determination threshold value Lxfsym (third threshold value).

A flower-position symmetry determination threshold value Lxfsym has been decided for every zoom position. If the flower is small, flower symmetry will have little influence upon the above-mentioned distance difference even if there is little flower symmetry. If the flower is large, however, flower symmetry will have a large influence upon the above-mentioned distance difference. Accordingly, the value obtained by dividing a flower-position symmetry determination coefficient Mn, which is a predetermined coefficient, by flower size Sxf (Sxf1 or Sxf2) will be the flower-position symmetry determination threshold value Lxfsym.

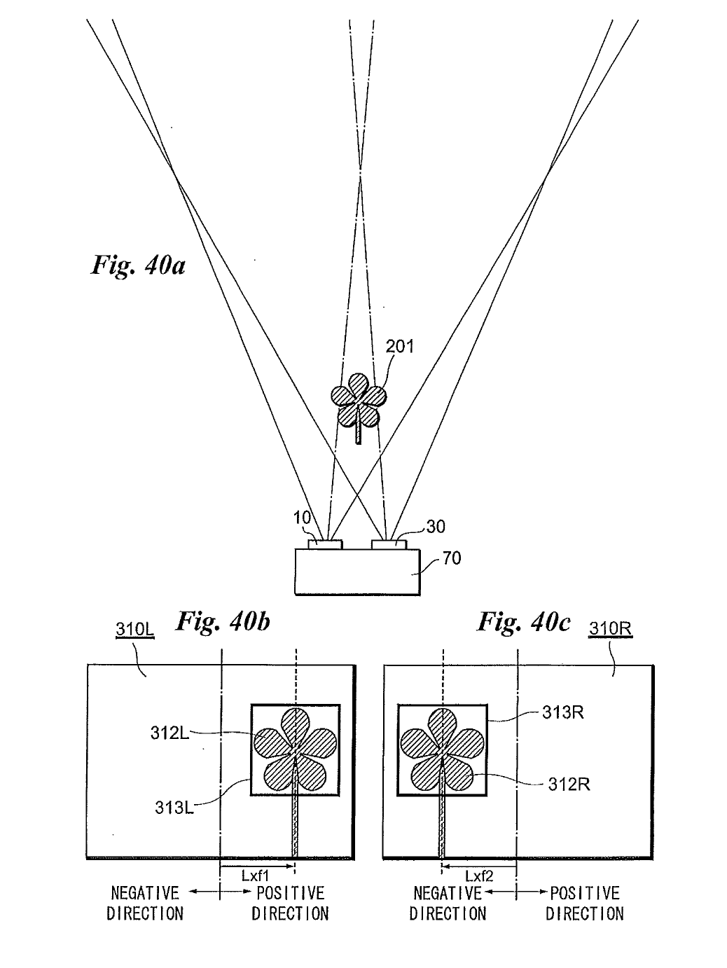

FIG. 40a illustrates the positional relationship between the stereoscopic imaging digital camera 70 and the subject, FIG. 40b an example of a left-eye image obtained by imaging, and FIG. 40c an example of a right-eye image obtained by imaging.

As shown in FIG. 40a, assume that the flower 201 is at the center of the viewing angle and, moreover, near the stereoscopic imaging digital camera 70.

With reference to FIG. 40b, a left-eye image 310L includes a flower 312L. A flower frame 313L enclosing a face 312L is being displayed as well. The flower 312L is offset to the right side (positive side) of the left-eye image 310L by the distance Lxf1.

With reference to FIG. 40c, a right-eye image 310R includes a flower 312R. A flower frame 313R enclosing a flower 312R is being displayed as well. The flower 312R is offset to the left side (negative side) of the right-eye image 310R by the distance Lxf2.

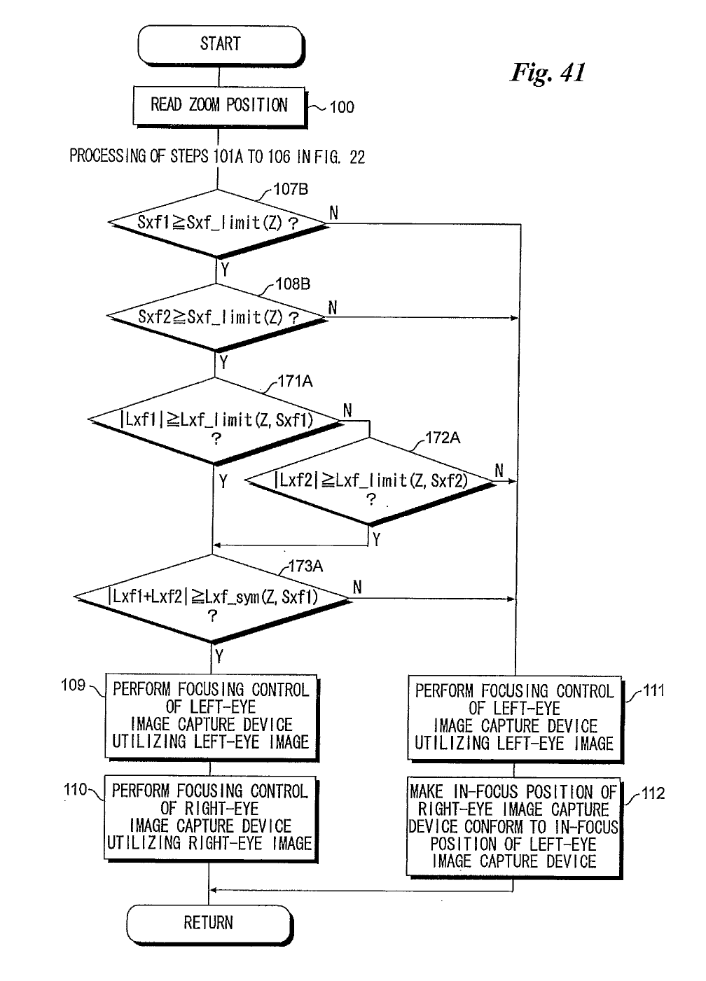

FIG. 41, which corresponds to FIG. 19, is a flowchart illustrating the processing procedure of the stereoscopic imaging digital camera. Processing steps in FIG. 41 identical with those shown in FIG. 37 are designated by like step numbers and need not be described again.

Symmetry of the flowers is represented by the absolute value |Lxf1+Lxf2| of the sum of the offsets from the centers of the flower images. If this absolute value is equal to or greater than the face-position symmetry determination threshold value Lxfsym (third threshold value) (“YES” at step 173A), then symmetry will have a large influence upon the distance difference, as mentioned above. Accordingly, focusing control of the left-eye image capture device 10 utilizing the left-eye image is carried out (step 109) and focusing control of the right-eye image utilizing the right-eye image is carried out (step 110).

If absolute value |Lxf1+Lxf2| of the sum of the offsets from the centers of the flower images is less than the flower-position symmetry determination threshold value Lxfsym (“NO” at step 173A), then symmetry will have a small influence upon the distance difference, as mentioned above. Accordingly, as described above, focusing control of the left-eye image capture device 10 utilizing the left-eye image is carried out (step 111) and focusing control of the right-eye image capture device 30 is carried out to make the in-focus position thereof conform to the in-focus position of the left-eye image capture device 10 (step 112).

1. A stereoscopic imaging digital camera comprising:
a left-eye image capture device for capturing a left-eye image constituting a stereoscopic image;
a first focusing lens freely movable along the direction of an optic axis of said left-eye image capture device;
a right-eye image capture device for capturing a right-eye image constituting the stereoscopic image;
a second focusing lens freely movable along the direction of an optic axis of said right-eye image capture device;
an object detection device for detecting objects, which are to be brought into focus, from respective ones of the left-eye image captured by said left-eye image capture device and right-eye image captured by said right-eye image capture device;
a determination device for determining whether the sizes of both of the objects, the one detected from the left-eye image by said object detection device and the one detected from the right-eye image by said object detection device, are both equal to or larger than a first threshold value; and
a focus control device, responsive to a determination made by said determination device that the sizes of both of the images are both equal to or larger than the first threshold value, for executing positioning of said first focusing lens, using the object detected from the left-eye image by said object detection device, in such a manner that the object detected from the left-eye image by said object detection device is brought into focus, and executing positioning of said second focusing lens, using the object detected from the right-eye image by said object detection device, in such a manner that the object detected from the right-eye image by said object detection device is brought into focus; and responsive to a determination made by said determination device that at least one object of both of the objects is smaller than the first threshold value, for executing either one of the positioning of said first focusing lens in such a manner that the object detected from the left-eye image by said object detection device is brought into focus or the positioning of said second focusing lens in such a manner that the object detected from the right-eye image by said object detection device is brought into focus, and, moreover, executing positioning of whichever focusing lens of said first focusing lens and said second focusing lens has not undergone positioning, to a position corresponding to a position that has been decided by either one of the positioning processes.

2. A stereoscopic imaging digital camera according to claim 1, wherein if it has been determined by said determination device that the sizes of both of the images are both equal to or greater than the first threshold value, then said focus control device, based upon the position of the object detected from the left-eye image by said object detection device and the position of the object detected from the right-eye image by said object detection device, switches between first positioning processing for executing positioning of said first focusing lens, using the object detected from the left-eye image by said object detection device, in such a manner that the object detected from the left-eye image by said object detection device is brought into focus, and for executing positioning of said second focusing lens, using the object detected from the right-eye image by said object detection device, in such a manner that the object detected from the right-eye image by said object detection device is brought into focus; and second positioning processing for executing either one of the positioning of said first focusing lens in such a manner that the object detected from the left-eye image by said object detection device is brought into focus or the positioning of said second focusing lens in such a manner that the object detected from the right-eye image by said object detection device is brought into focus, and, moreover, executing positioning of whichever focusing lens of said first focusing lens and said second focusing lens has not undergone positioning, to a position corresponding to a position that has been decided by either one of the positioning processes.

3. A stereoscopic imaging digital camera according to claim 2, wherein in response to a determination by said determination device that the sizes of both of the images are both equal to or greater than the first threshold value and, moreover, on account of at least one of the object detected from the left-eye image by said object detection device and the object detected from the right-eye image by said object detection device being spaced away from the center of the image horizontally by more than a second threshold value, said focus control device executes positioning of said first focusing lens, using the object detected from the left-eye image by said object detection device, in such a manner that the object detected from the left-eye image by said object detection device is brought into focus, and executes positioning of said second focusing lens, using the object detected from the right-eye image by said object detection device, in such a manner that the object detected from the right-eye image by said object detection device is brought into focus; and in response to a determination made by said determination device that at least one object of both of the objects is smaller than the first threshold value and, moreover, on account of both the object detected from the left-eye image by said object detection device and the object detected from the right-eye image by said object detection device not being spaced away from the centers of the images horizontally by more than the second threshold value, said focus control device executes either one of the positioning of said first focusing lens in such a manner that the object detected from the left-eye image by said object detection device is brought into focus or the positioning of said second focusing lens in such a manner that the object detected from the right-eye image by said object detection device is brought into focus, and, moreover, executes positioning of whichever focusing lens of said first focusing lens and said second focusing lens has not undergone positioning, to a position corresponding to a position that has been decided by either one of the positioning processes.

4. A stereoscopic imaging digital camera according to claim 3, wherein in response to a determination by said determination device that the sizes of both of the images are equal to or greater than the first threshold value, and on account of at least one of the object detected from the left-eye image by said object detection device and the object detected from the right-eye image by said object detection device being spaced away from the center of the image horizontally by more than a second threshold value and, moreover, the absolute value of the sum of amount of horizontal offset from the center of the object detected from the left-eye image by said object detection device and amount of horizontal offset from the center of the object detected from the right-eye image by said object detection device being equal to or greater than a third threshold value, said focus control device executes positioning of said first focusing lens, using the object detected from the left-eye image by said object detection device, in such a manner that the object detected from the left-eye image by said object detection device is brought into focus, and executes positioning processing of said second focusing lens of said second focusing lens, using the object detected from the right-eye image by said object detection device, in such a manner that the object detected from the right-eye image by said object detection device is brought into focus; and in response to a determination made by said determination device that at least one object of both of the objects is smaller than the first threshold value, and on account of both the object detected from the left-eye image by said object detection device and the object detected from the right-eye image by said object detection device not being spaced away from the centers of the images horizontally by more than the second threshold value, and, moreover, the absolute value of the sum of amount of horizontal offset from the center of the object detected from the left-eye image by said object detection device and amount of horizontal offset from the center of the object detected from the right-eye image by said object detection device being less than the third threshold value, said focus control device executes either one of the positioning of said first focusing lens in such a manner that the object detected from the left-eye image by said object detection device is brought into focus or the positioning of said second focusing lens in such a manner that the object detected from the right-eye image by said object detection device is brought into focus, and, moreover, executes positioning of whichever focusing lens of said first focusing lens and said second focusing lens has not undergone positioning, to a position corresponding to a position that has been decided by either one of the positioning processes.

5. A stereoscopic imaging digital camera according to claim 4, further comprising:
a first zoom lens provided in front of said left-eye image capture device; and
a second zooms lens provided in front of said right-eye image capture device;
wherein at least one threshold value from among said first threshold value, said second threshold value and said third threshold value has been decided based upon position of said first zoom lens and position of said second zoom lens.

6. A method of controlling operation of a stereoscopic imaging digital camera having a left-eye image capture device for capturing a left-eye image constituting a stereoscopic image, a first focusing lens freely movable along the direction of an optic axis of the left-eye image capture device, a right-eye image capture device for capturing a right-eye image constituting the stereoscopic image, and a second focusing lens freely movable along the direction of an optic axis of the right-eye image capture device, said method comprising:
an object detection device detecting objects, which are to be brought into focus, from respective ones of the left-eye image captured by said left-eye image capture device and right-eye image captured by said right-eye image capture device; a determination device determining whether the sizes of both of the objects, the one detected from the left-eye image by said object detection device and the one detected from the right-eye image by said object detection device, are equal to or larger than a first threshold value; and in response to a determination made by said determination device that the sizes of both of the images are equal to or larger than the first threshold value, a focus control device executing positioning of said first focusing lens, using the object detected from the left-eye image by said object detection device, in such a manner that the object detected from the left-eye image by said object detection device is brought into focus, and executing positioning of said second focusing lens, using the object detected from the right-eye image by said object detection device, in such a manner that the object detected from the right-eye image by said object detection device is brought into focus; and in response to a determination made by said determination device that at least one object of both of the objects is smaller than the first threshold value, said focus control device executing either one of the positioning of said first focusing lens in such a manner that the object detected from the left-eye image by said object detection device is brought into focus or the positioning of said second focusing lens in such a manner that the object detected from the right-eye image by said object detection device is brought into focus, and, moreover, executing positioning of whichever focusing lens of said first focusing lens and said second focusing lens has not undergone positioning, to a position corresponding to a position that has been decided by either one of the positioning processes.
